(19) United States
(12) Patent Application Publication
(10) Pub. No.: US 2018/0308015 A1
(43) Pub. Date: Oct. 25, 2018

(54) PARKING SPOT RESERVATION SYSTEM AND METHOD

(71) Applicants: Vivek Ashok Kumar, Newark, NJ (US); Vinicius Frigatti, Harrison, NJ (US); Christopher Magesty, Kearny, NJ (US); Jasper Davey, Bloomfield, NJ (US); Dhruv Shah, Piscataway, NJ (US); Patricia Iglesias-Montoro, Haledon, NJ (US); Peter Nguyen, New Rochelle, NY (US)

(72) Inventors: Vivek Ashok Kumar, Newark, NJ (US); Vinicius Frigatti, Harrison, NJ (US); Christopher Magesty, Kearny, NJ (US); Jasper Davey, Bloomfield, NJ (US); Dhruv Shah, Piscataway, NJ (US); Patricia Iglesias-Montoro, Haledon, NJ (US); Peter Nguyen, New Rochelle, NY (US)

(21) Appl. No.: 15/957,607

(22) Filed: Apr. 19, 2018

Related U.S. Application Data
(60) Provisional application No. 62/642,762, filed on Mar. 14, 2018.
(60) Provisional application No. 62/487,338, filed on Apr. 19, 2017.

(51) Int. Cl. G06Q 10/02

(52) U.S. Cl. CPC G06Q 10/02

(57) ABSTRACT

The present disclosure relates to a system and method for soliciting offers and reservations for parking spots. The system and method is, in some instances, embodied as a mobile application that connects users to exchange the current physical space (e.g. parking spaces) in exchange for the same user's or another user's time, money, gratuity or service.

### CLAIM OF PRIORITY

This application is claims priority to U.S. application Ser. No. 62/642,762 filed on Mar. 14, 2018 and U.S. application Ser. No. 62/487,338 filed on Apr. 19, 2017, the contents of both of which are herein fully incorporated by reference in their entirety.

### FIELD OF THE EMBODIMENTS

The field of the embodiments of the present invention relate to an application and method for soliciting offers and reservations for parking spots.

### BACKGROUND OF THE EMBODIMENTS

Parking a car in many cities is a frustrating adventure due to the scarcity of public parking and the high cost of what parking is available. Although public parking, including but not limited to meters, residential parking, un-metered parking spots, etc. can be expensive or and inconvenient because the supply of parking spots. Thus, finding a suitable parking spot typically requires some combination of time, luck, and/or money. Parking garages or parking spots with meters or other charged parking may be more convenient in a convenient location, but is not easy to find, and the cost of such a parking spot is significantly higher. However, even these spots may be in limited supply. Facilitation of exchange of these spots in an electronic, or otherwise, platform can enhance acquisition of parking. In an added benefit, the departing party, the party leaving their parking spot can potentially be compensated for their waiting time.

The increasing reliance on automobiles combined with the limited space for parking, particularly in urban areas, has led to serious problems in parking management in today's society. Even further, it is expensive and logistically cumbersome for police or law enforcement officers to keep track of offenders who park their vehicles without paying for the parking space. Parking meters do not fully solve the problem because they require a large investment on the part of the municipality and comprehensive monitoring by enforcement personnel.

Another parking management problem is the ever-growing lack of parking space available. It is difficult, if not impossible, for a driver wishing to travel to an urban district to know ahead of time if there even will be any available parking space. In short, there is a lack of communication in the field of parking management, between municipality, driver, and parking space.

Therefore, to address these problems and to provide a much convenient, better accessible and cost effective parking solution, there is a long felt need to develop a system and method which will be able to connect users leaving a parking location with those who are seeking one. The present invention and its embodiments meet and exceeds these objectives.

For example, U.S. Pat. No. 9,761,139 pertains a method to provide an active parking system that includes receiving, at a portable computerized device, parking preferences of a user for a parking facility of a retail store, determining, within a parking space index server, an availability status of each of a plurality of parking spaces of the parking facility, identifying, within a computerized device, a preferred parking location for the user based upon the parking preferences and the availability statuses, and displaying, at a computerized display, directions for the user to navigate to the preferred parking location.

U.S. Patent Application 2013/0073350 pertains to a system and method for allowing owners of private parking spots to rent their parking spots for occasional vehicles in real time, wherein the system is able to distinguish between occasional vehicles parked in the parking spot and vehicles belonging to the owner of the parking lot.

Chinese Application 107146467 pertains to a parking space sharing implementation method for residence community. The method includes steps that an estate management unit counts residents that are willing to rent out parking spaces in idle time; the estate management unit releases parking space attributes of the residents on a parking space management information platform; vehicle plate numbers and entrance and exit time of vehicles driving into and out of a community are detected through a vehicle plate identification system and vehicle state on the parking space management information platform is updated in real time; vehicle plate numbers and contact phone numbers are input on the parking space management information platform in advance as for temporarily parking vehicles so as to choose appropriate parking spaces that can be appointed and the parking spaces are shown in an appointed state at the same time; when temporarily parking vehicles having appointment arrives the parking spaces at appointed time, the vehicle plate detection system at the entrance of the community detects the vehicle plates and the entrance time of the temporarily parking vehicles; the estate management unit collects fees according to parking time length from the temporarily parking vehicles driving out of the community.

Various devices are known in the art. However, their structure and means of operation are substantially different from the present disclosure. The other inventions fail to solve all the problems taught by the present disclosure. At least one embodiment of this invention is presented in the drawings below and will be described in more detail herein.

### SUMMARY OF THE EMBODIMENTS

Generally, the present invention and its embodiments provide for an application by which users can exchange space for time, money, gratuities, services, etc. At its core, the application is, in some instances, a mobile application that connects users to exchange the current physical space (e.g. parking spaces) in exchange for the same user's or another user's time, money, gratuity or service. Preferably, users of the app fall into two different categories: an arriving user and a departing user. An arriving user gets to select from a variety of parking spaces posted by departing users or other partners of the application. Parking spaces can be defined as any space that can allow for parking a vehicle, momentary stasis of a vehicle, or even occupation of the space for any other purpose. More specifically, the arriving user selects a physical space for which they compensate the departing user for their time. In turn, the embodiments of this application allows users to find parking effectively while departing users get compensated for listing their parking location and waiting their selected time.

In one embodiment of the present invention there is a system for managing at least one parking space, the system having a parking system program executed by at least one electronic device, the parking system program having a rendezvous module, wherein the rendezvous module is activated when a user accepts at least one parking location, the rendezvous module performing the steps of: estimating a time of arrival of the second user to the first parking location; providing first vehicle information (e.g. vehicle information such as license plate number, a color, a model, a manufacturer, a length, a width, or a combination thereof, GPS location, present and past location capture and storage, IP address, and other system information such as time and other phone variable) of the first user to the second user; and providing second vehicle information (as above) of the second user to the first user; a parking system program parking database configured to store criteria associated with one or more parking locations, wherein the criteria is at least one of a waiting period, a compensation level, a location, and a type of a parking location; a parking system program user database configured to store criteria associate with one or more users, wherein the criteria is at least one of a location preference, a rating, a description of at least one vehicle, and usage history.

In another embodiment of the present invention there is a computer implemented parking method comprising: a first user inputting criteria for a first parking location into a parking system program, wherein the criteria comprises at least a waiting period and a compensation level, wherein the compensation level is modified by the parking system program; a second user selecting the first parking location from one or more parking locations in the parking system program, wherein if the second user accepts the first parking location, then the parking system program enters a rendezvous mode, wherein the rendezvous mode comprises the steps of: the parking system program estimating a time of arrival of the second user to the first parking location; the parking system program providing first vehicle information of the first user to the second user; and the parking system program providing second vehicle information of the second user to the first user. It then routes the second user to the location of the first user while displaying the second users' location to the first user.

In yet another embodiment of the present invention there is a non-transitory computer-readable medium storing computing instructions for operation of a parking system program, the computing instructions operating upon a portable computerized device and configured to instruct the portable computerized device to perform acts, comprising the steps of: a first user inputting criteria for a first parking location into a parking system program, wherein the criteria comprises of at least a waiting period and a compensation level, wherein the compensation level is modified by the parking system program; a second user selecting the first parking location from one or more parking locations in the parking system program, wherein if the second user accepts the first parking location, then the parking system program enters a rendezvous mode, wherein the rendezvous mode comprises the steps of: the parking system program estimating a time of arrival of the second user to the first parking location; the parking system program providing first vehicle information (comprising of information as stated in other embodiments above) of the first user to the second user; the parking system program providing second vehicle information of the second user to the first user; the parking system displaying routing/directions/akin information of the first user to the second user; the parking system displays the seconds user suggested traveling path to the first user.

In general, the present invention and its embodiments succeed in conferring the following, and others not mentioned, benefits and objectives.

It is an object of an embodiment of the present invention to provide a parking system that compensates one for temporary use of their parking spot.

It is an object of an embodiment of the present invention to provide a parking system the disincentives poor performance on behalf of the users of the system.

It is an object of an embodiment of the present invention to provide a parking system assist in finding a parking spot or other physical location.

It is an object of an embodiment of the present invention to provide a parking system that helps to streamline traffic within a given location.

It is an object of an embodiment of the present invention to provide a parking system that monitors behaviors and activities of users.

It is an object of an embodiment of the present invention to provide a parking system exchanges vehicle information between users to facilitate the swapping of the parking locations.

It is an object of an embodiment of the present invention to provide a parking system that utilizes a price logic to determine cost of a parking location.

It is an object of an embodiment of the present invention to provide a parking system that is intuitive and easy to use.

It is an object of an embodiment of the present invention to provide a parking system that displays a number of variables to help one find the perfect parking location.

It is an object of an embodiment of the present invention to provide a parking system that can be safe and effective.

It is an object of an embodiment of the present invention to provide a parking system that allows one to monetize what would be otherwise unused, un-monetized, or otherwise defined space or time.

### BRIEF DESCRIPTION OF THE DRAWINGS

FIG. 1 is an example screen of an embodiment of the parking application illustrating a reservation screen.

FIG. 2 is an example screen of an embodiment of the parking application illustrating a departing screen without spots shown.

FIG. 3 is an example screen of an embodiment of the parking application illustrating the rendezvous mode.

FIG. 4 is an example screen of an embodiment of the parking application illustrating a review functionality.

FIG. 5 is an example screen of an embodiment of the parking application illustrating the first user waiting for a match to enter rendezvous mode.

FIG. 6 is an example screen of an embodiment of the parking application illustrating the second user acknowledging confirmation to enter rendezvous mode with the listed user.

FIG. 7 is an example screen of an embodiment of the parking application illustrating the dashboard map showing parking spaces and pricing of those spaces listed in the given area.

FIG. 8 is an example screen of an embodiment of the parking application illustrating the confirmation of a transaction for the first user with review functionality.

FIGS. 9A-9CC are an example screen of an embodiment of the parking application illustrating the storyboard of the application's components/pages.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to each embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

### Systems, Devices and Operating Systems

Typically, a user or users, which may be people or groups of users and/or other systems, may engage information technology systems (e.g., computers) to facilitate operation of the system and information processing. In turn, computers employ processors to process information and such processors may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the present invention may be connected to and/or communicate with entities such as, but not limited to: one or more users from user input devices; peripheral devices; an optional cryptographic processor device; and/or a communications network. For example, the present invention may be connected to and/or communicate with users, operating client device(s), including, but not limited to, personal computer(s), server(s) and/or various mobile device(s) including, but not limited to, cellular telephone(s), smartphone(s) (e.g., iPhone®, Blackberry®, Android OS-based phones etc.), tablet computer(s) (e.g., Apple iPad™, HP Slate™, Motorola Xoom™, etc.), eBook reader(s) (e.g., Amazon Kindle™, Barnes and Noble's Nook™ eReader, etc.), laptop computer(s), notebook(s), netbook(s), gaming console(s) (e.g., XBOX Live™, Nintendo® DS, Sony PlayStation® Portable, etc.), portable scanner(s) and/or the like.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The present invention may be based on computer systems that may comprise, but are not limited to, components such as: a computer systemization connected to memory.

Computer Systemization

A computer systemization may comprise a clock, central processing unit (“CPU(s)” and/or “processor(s)” (these terms are used interchangeable throughout the disclosure unless noted to the contrary)), a memory (e.g., a read only memory (ROM), a random access memory (RAM), etc.), and/or an interface bus, and most frequently, although not necessarily, are all interconnected and/or communicating through a system bus on one or more (mother)board(s) having conductive and/or otherwise transportive circuit pathways through which instructions (e.g., binary encoded signals) may travel to effect communications, operations, storage, etc. Optionally, the computer systemization may be connected to an internal power source; e.g., optionally the power source may be internal. Optionally, a cryptographic processor and/or transceivers (e.g., ICs) may be connected to the system bus. In another embodiment, the cryptographic processor and/or transceivers may be connected as either internal and/or external peripheral devices via the interface bus I/O. In turn, the transceivers may be connected to antenna(s), thereby effectuating wireless transmission and reception of various communication and/or sensor protocols; for example the antenna(s) may connect to: a Texas Instruments WiLink WL1283 transceiver chip (e.g., providing 802.11n, Bluetooth 3.0, FM, global positioning system (GPS) (thereby allowing the controller of the present invention to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. Of course, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the present invention and beyond through various interfaces. Should processing requirements dictate a greater amount speed and/or capacity, distributed processors (e.g., Distributed embodiments of the present invention), mainframe, multi-core, parallel, and/or super-computer architectures may similarly be employed. Alternatively, should deployment requirements dictate greater portability, smaller Personal Digital Assistants (PDAs) may be employed.

Depending on the particular implementation, features of the present invention may be achieved by implementing a microcontroller such as CAST's R8051XC2 microcontroller; Intel's MCS 51 (i.e., 8051 microcontroller); and/or the like. Also, to implement certain features of the various embodiments, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the component collection (distributed or otherwise) and/or features of the present invention may be implemented via the microprocessor and/or via embedded components; e.g., via ASIC, coprocessor, DSP, FPGA, and/or the like. Alternately, some implementations of the present invention may be implemented with embedded components that are configured and used to achieve a variety of features or signal processing.

Depending on the particular implementation, the embedded components may include software solutions, hardware solutions, and/or some combination of both hardware/software solutions. For example, features of the present invention discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the features of the present invention. A hierarchy of programmable interconnects allow logic blocks to be interconnected as needed by the system designer/administrator of the present invention, somewhat like a one-chip programmable breadboard. An FPGA's logic blocks can be programmed to perform the function of basic logic gates such as AND, and XOR, or more complex combinational functions such as decoders or simple mathematical functions. In most FPGAs, the logic blocks also include memory elements, which may be simple flip-flops or more complete blocks of memory. In some circumstances, the present invention may be developed on regular FPGAs and then migrated into a fixed version that more resembles ASIC implementations. Alternate or coordinating implementations may migrate features of the controller of the present invention to a final ASIC instead of or in addition to FPGAs. Depending on the implementation all of the aforementioned embedded components and microprocessors may be considered the “CPU” and/or “processor” for the present invention.

Power Source

The power source may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell is connected to at least one of the interconnected subsequent components of the present invention thereby providing an electric current to all subsequent components. In one example, the power source is connected to the system bus component. In an alternative embodiment, an outside power source is provided through a connection across the I/O interface. For example, a USB and/or IEEE 1394 connection carries both data and power across the connection and is therefore a suitable source of power.

Interface Adapters

Interface bus(ses) may accept, connect, and/or communicate to a number of interface adapters, conventionally although not necessarily in the form of adapter cards, such as but not limited to: input output interfaces (I/O), storage interfaces, network interfaces, and/or the like. Optionally, cryptographic processor interfaces similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces may accept, communicate, and/or connect to a number of storage devices such as, but not limited to: storage devices, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces may accept, communicate, and/or connect to a communications network. Through a communications network, the controller of the present invention is accessible through remote clients (e.g., computers with web browsers) by users. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed embodiments of the present invention), architectures may similarly be employed to pool, load balance, and/or otherwise increase the communicative bandwidth required by the controller of the present invention. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces may be used to engage with various communications network types. For example, multiple network interfaces may be employed to allow for the communication over broadcast, multicast, and/or unicast networks.

Input Output interfaces (I/O) may accept, communicate, and/or connect to user input devices, peripheral devices, cryptographic processor devices, and/or the like. I/O may employ connection protocols such as, but not limited to: audio: analog, digital, monaural, RCA, stereo, and/or the like; data: Apple Desktop Bus (ADB), IEEE 1394a-b, serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices often are a type of peripheral device (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices and the like may be connected and/or communicate to I/O and/or other facilities of the like such as network interfaces, storage interfaces, directly to the interface bus, system bus, the CPU, and/or the like. Peripheral devices may be external, internal and/or part of the controller of the present invention. Peripheral devices may also include, for example, an antenna, audio devices (e.g., line-in, line-out, microphone input, speakers, etc.), cameras (e.g., still, video, webcam, etc.), drive motors, lighting, video monitors and/or the like.

Cryptographic units such as, but not limited to, microcontrollers, processors, interfaces, and/or devices may be attached, and/or communicate with the controller of the present invention. A MC68HC16 microcontroller, manufactured by Motorola Inc., may be used for and/or within cryptographic units. The MC68HC16 microcontroller utilizes a 16-bit multiply-and-accumulate instruction in the 16 MHz configuration and requires less than one second to perform a 512-bit RSA private key operation. Cryptographic units support the authentication of communications from interacting agents, as well as allowing for anonymous transactions. Cryptographic units may also be configured as part of CPU. Equivalent microcontrollers and/or processors may also be used. Other commercially available specialized cryptographic processors include: the

Broadcom's CryptoNetX and other Security Processors; nCipher's nShield, SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

Memory

Generally, any mechanization and/or embodiment allowing a processor to affect the storage and/or retrieval of information is regarded as memory. However, memory is a fungible technology and resource, thus, any number of memory embodiments may be employed in lieu of or in concert with one another. It is to be understood that the controller of the present invention and/or a computer systemization may employ various forms of memory. For example, a computer systemization may be configured wherein the functionality of on-chip CPU memory (e.g., registers), RAM, ROM, and any other storage devices are provided by a paper punch tape or paper punch card mechanism; of course such an embodiment would result in an extremely slow rate of operation. In a typical configuration, memory will include ROM, RAM, and a storage device. A storage device may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

Component Collection

The memory may contain a collection of program and/or database components and/or data such as, but not limited to: operating system component(s) (operating system); information server component(s) (information server); user interface component(s) (user interface); Web browser component(s) (Web browser); database(s); mail server component(s); mail client component(s); cryptographic server component(s) (cryptographic server) and/or the like (i.e., collectively a component collection). These components may be stored and accessed from the storage devices and/or from storage devices accessible through an interface bus. Although non-conventional program components such as those in the component collection, typically, are stored in a local storage device, they may also be loaded and/or stored in memory such as: peripheral devices, RAM, remote storage facilities through a communications network, ROM, various forms of memory, and/or the like.

Operating System

The operating system component is an executable program component facilitating the operation of the controller of the present invention. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millennium/NT/Vista/XP (Server), Palm OS, and/or the like. The operating system may be one specifically optimized to be run on a mobile computing device, such as iOS, Android, Windows Phone, Tizen, Symbian, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the controller of the present invention to communicate with other entities through a communications network. Various communication protocols may be used by the controller of the present invention as a subcarrier transport mechanism for interaction, such as, but not limited to: multicast, TCP/IP, UDP, unicast, and/or the like.

Information Server

An information server component is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the controller of the present invention based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port, and/or the like. An information server may communicate to and/or with other components in a component collection, including itself, and/or facilities of the like. Most frequently, the information server communicates with the database of the present invention, operating systems, other program components, user interfaces, Web browsers, and/or the like.

Access to the database of the present invention may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the present invention. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the present invention as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 2000/2003/3.1/95/98/CE/Millennium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery(UI), MooTools, Prototype, script.aculo.us, SWFObject, Yahoo! User Interface, any of which may be used and) provide a baseline and means of accessing and displaying information graphically to users.

A user interface component is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

Web Browser

A Web browser component is a stored program component that is executed by a CPU. The Web browser may be a conventional hypertext viewing application such as Microsoft Internet Explorer or Netscape Navigator. Secure Web browsing may be supplied with 128bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., FireFox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Of course, in place of a Web browser and information server, a combined application may be developed to perform similar functions of both. The combined application would similarly affect the obtaining and the provision of information to users, user agents, and/or the like from the enabled nodes of the present invention. The combined application may be nugatory on systems employing standard Web browsers.

Mail Server

A mail server component is a stored program component that is executed by a CPU. The mail server may be a conventional Internet mail server such as, but not limited to sendmail, Microsoft Exchange, and/or the like. The mail server may allow for the execution of program components through facilities such as ASP, ActiveX, (ANSI) (Objective-) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POP3), simple mail transfer protocol (SMTP), and/or the like. The mail server can route, forward, and process incoming and outgoing mail messages that have been sent, relayed and/or otherwise traversing through and/or to the present invnetion.

Access to the mail of the present invention may be achieved through a number of APIs offered by the individual Web server components and/or the operating system. Also, a mail server may contain, communicate, generate, obtain, and/or provide program component, system, user, and/or data communications, requests, information, and/or responses.

Mail Client

A mail client component is a stored program component that is executed by a CPU. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POP3, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

Cryptographic Server

A cryptographic server component is a stored program component that is executed by a CPU, cryptographic processor, cryptographic processor interface, cryptographic processor device, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash function), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the present invention may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the component of the present invention to engage in secure transactions if so desired. The cryptographic component facilitates the secure accessing of resources on the present invention and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

A Database of the Present Invention

The database component of the present invention may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the database of the present invention may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the exception that objects are not just pieces of data but may have other types of functionality encapsulated within a given object. If the database of the present invention is implemented as a data-structure, the use of the database of the present invention may be integrated into another component such as the component of the present invention. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

Embodiments of the Present Invention

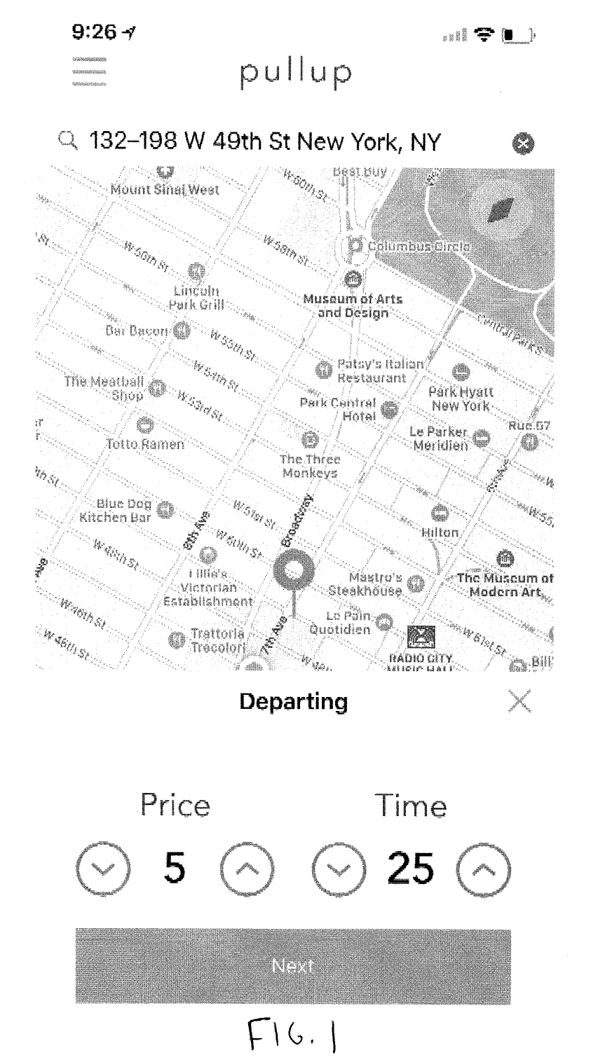

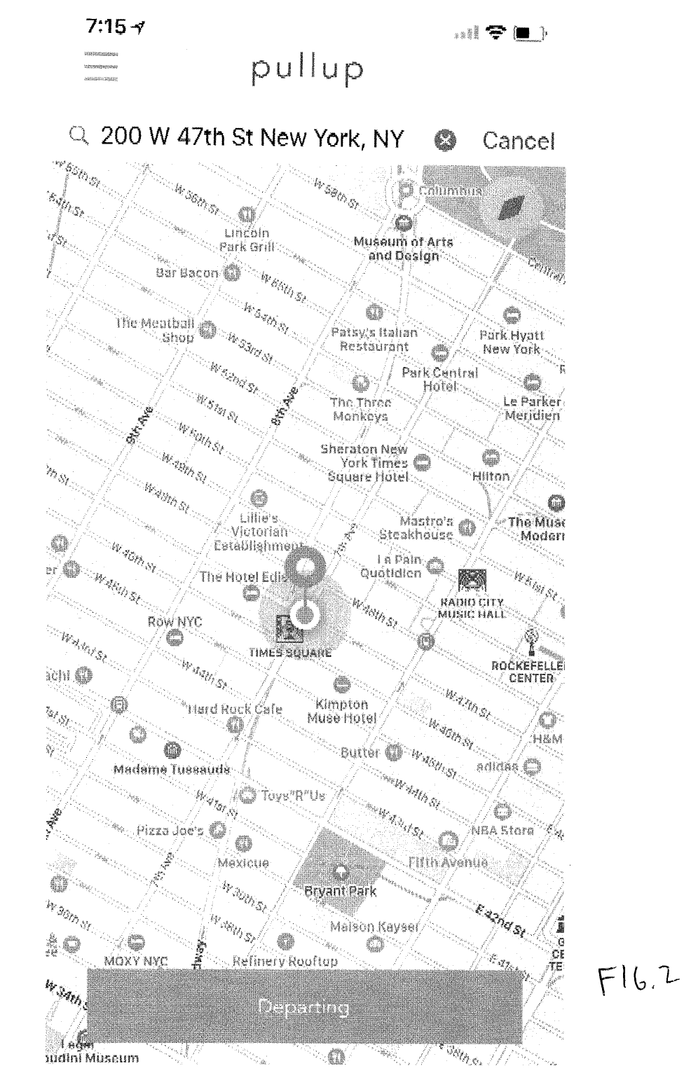

Referring now to FIGS. 1-9, there are exemplary screen intended to demonstrate functionality associated with embodiments of the present invention. The exemplary screens are intended to be demonstrative only and may or may not be representative of representations created on a physical device.

In FIG. 1, the departing user is able to set the desired waiting time and price for the parking space reservation in order for an arriving user to select. The price which the departing user selects is what he will be awarded for a successful transaction.

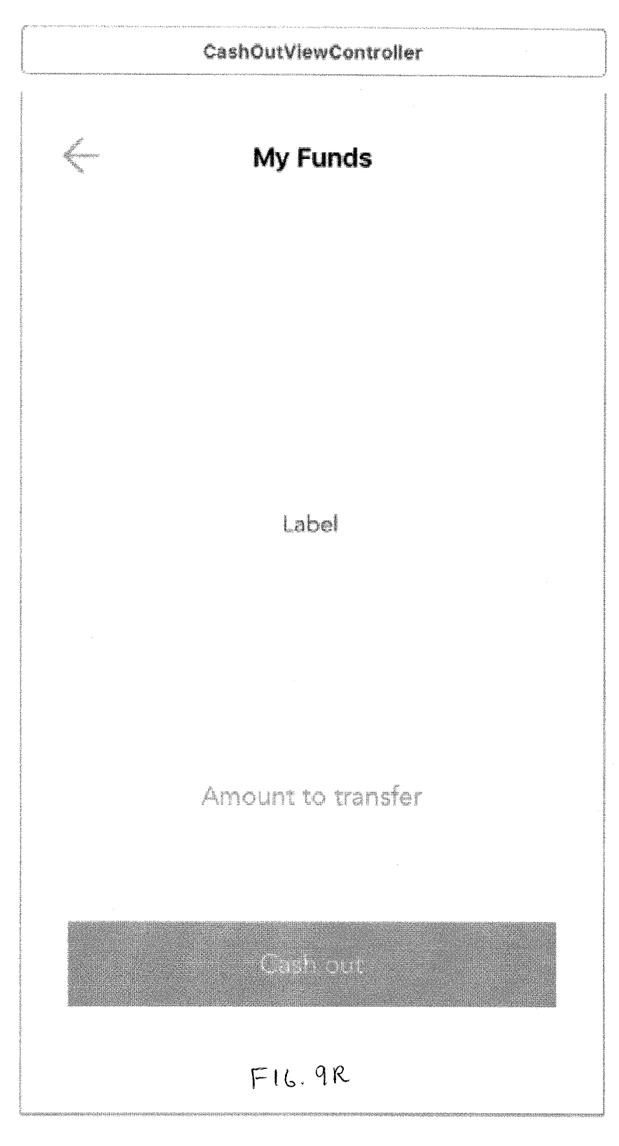

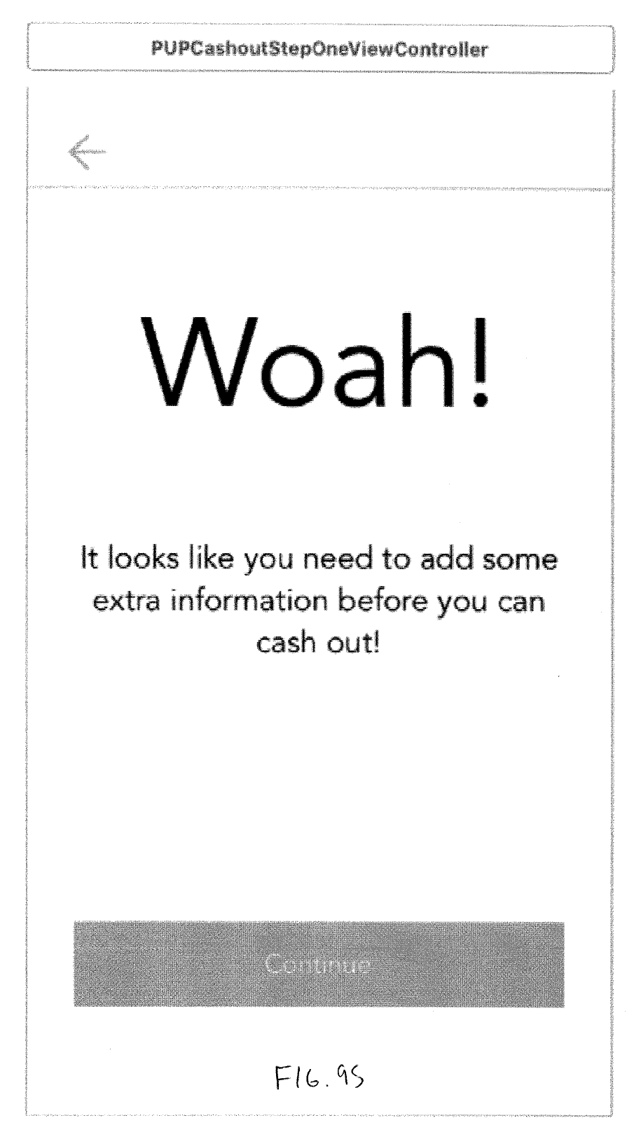

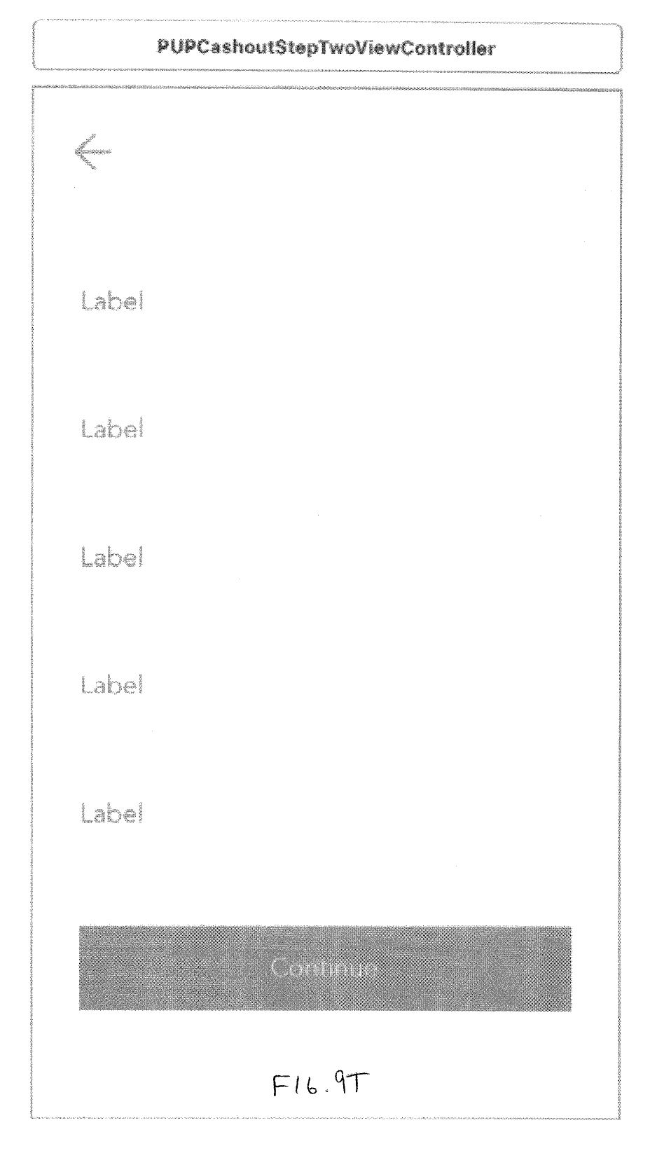

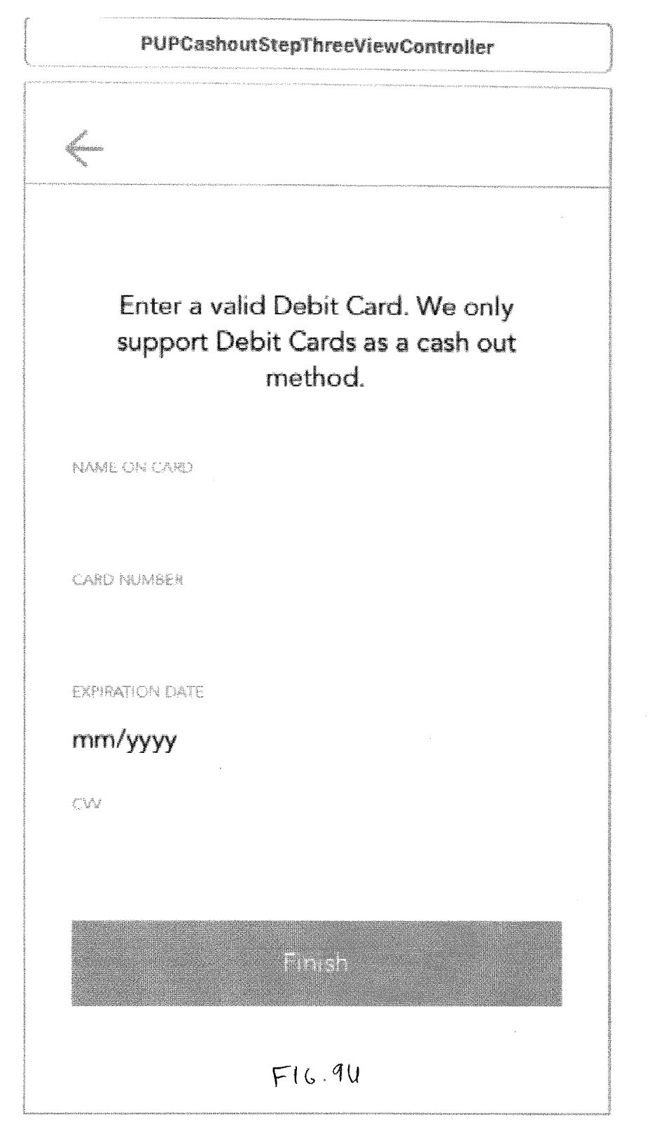

In FIG. 2, this is the initial screen in which the app startup will center. In this version of the image—no parking spots are listed. A detailed version showing spots with a description and overlay is showing in FIG. 7 below.

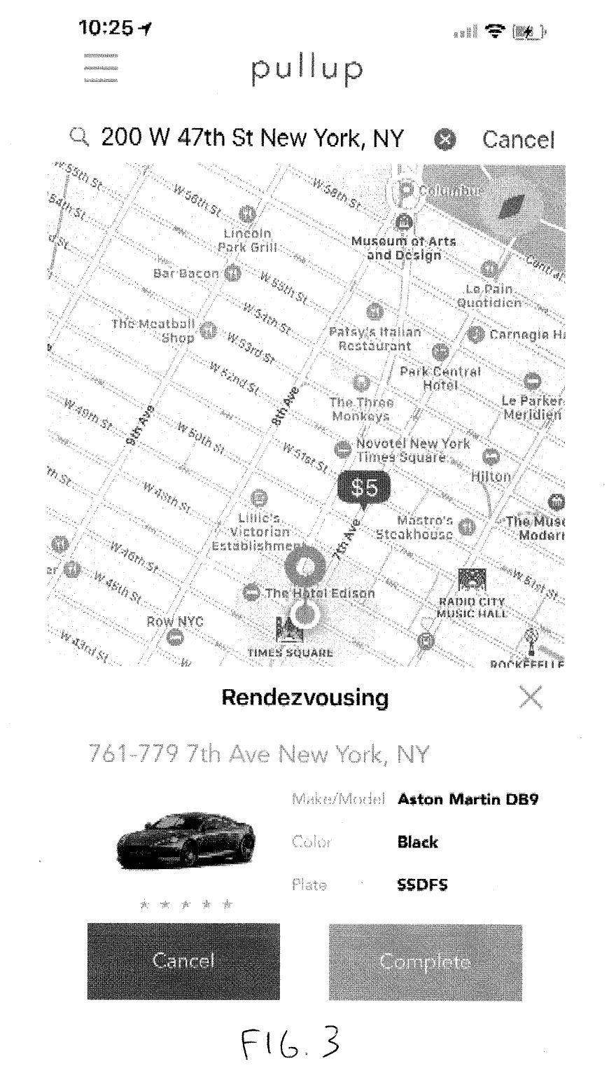

In FIG. 3, the part of the process that's shown is a user currently in “rendezvous mode”. Here both the arriving user and departing user have matched. They have each other's vehicles' information displayed. They have additional user information about the other party in the transaction displayed. There are two options that both users will see on their screen as shown in FIG. 3, once a successful rendezvous takes place which both users facilitate the exchange of space then both users can “Complete” the transaction by initiating the complete button or similar During the rendezvous process, if there is any reason in which either user does not want to complete the transaction they can also initiate the “Cancel” button.

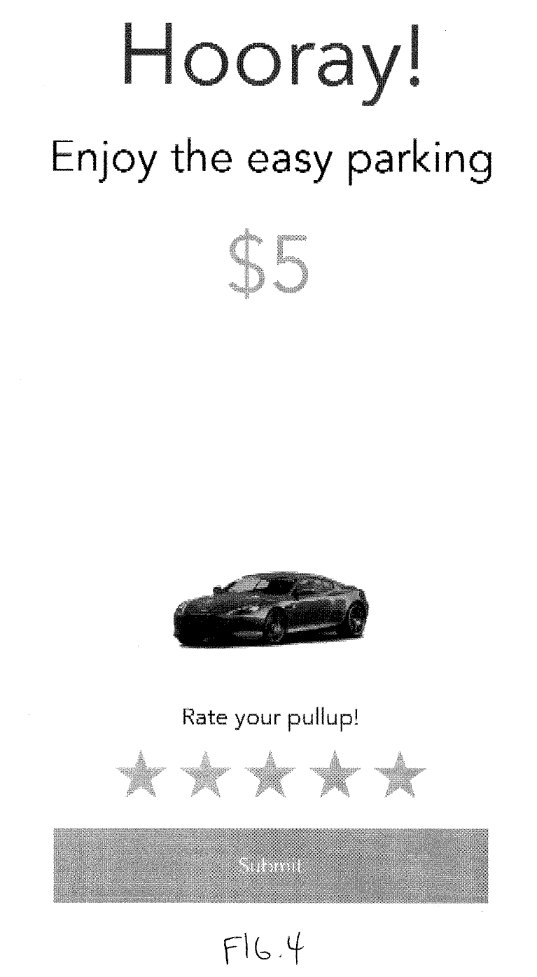

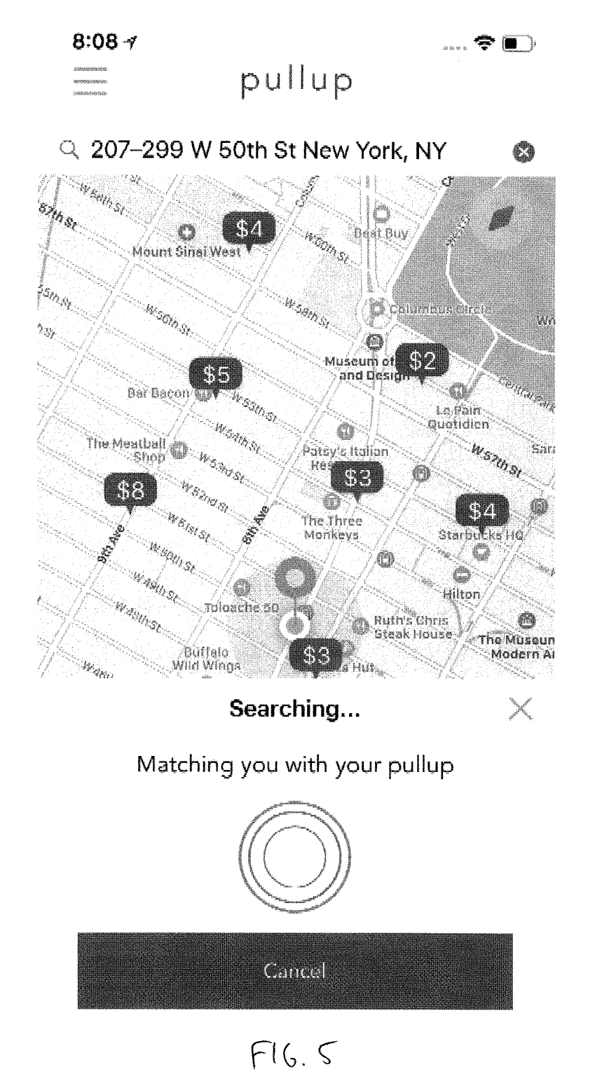

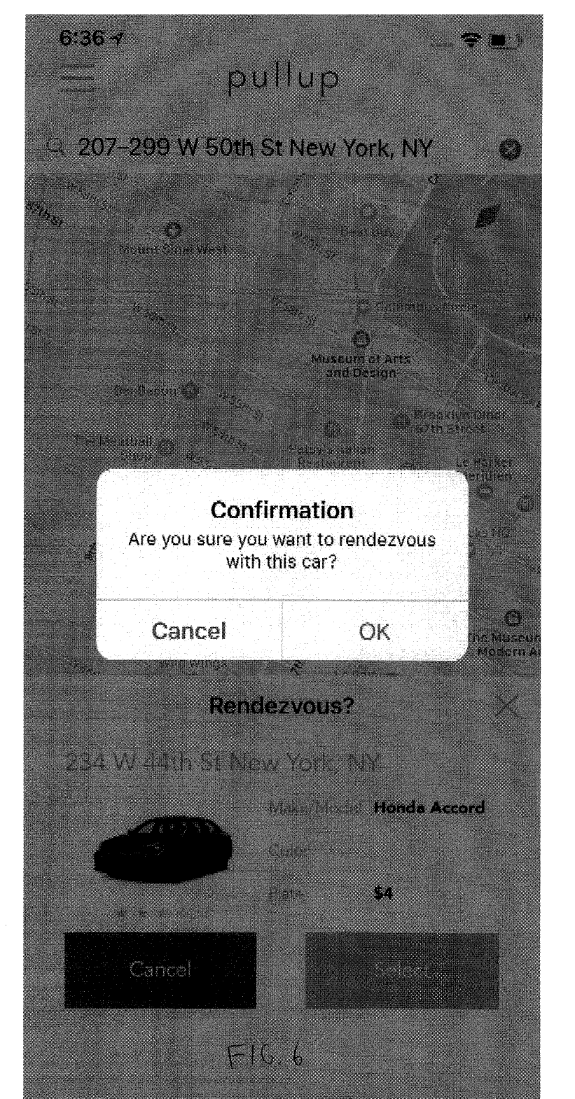

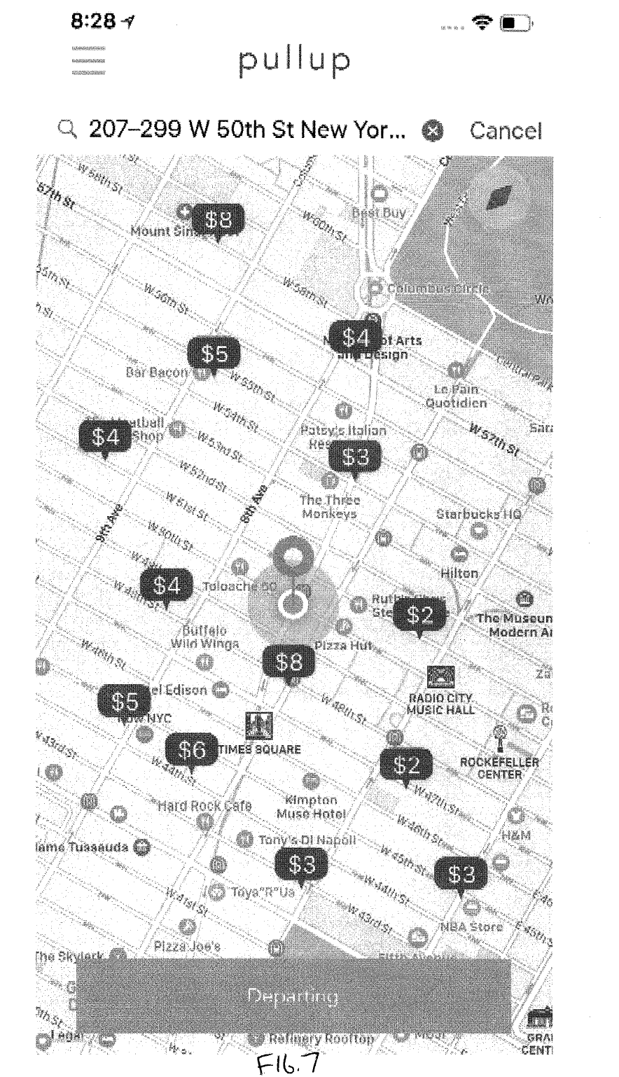

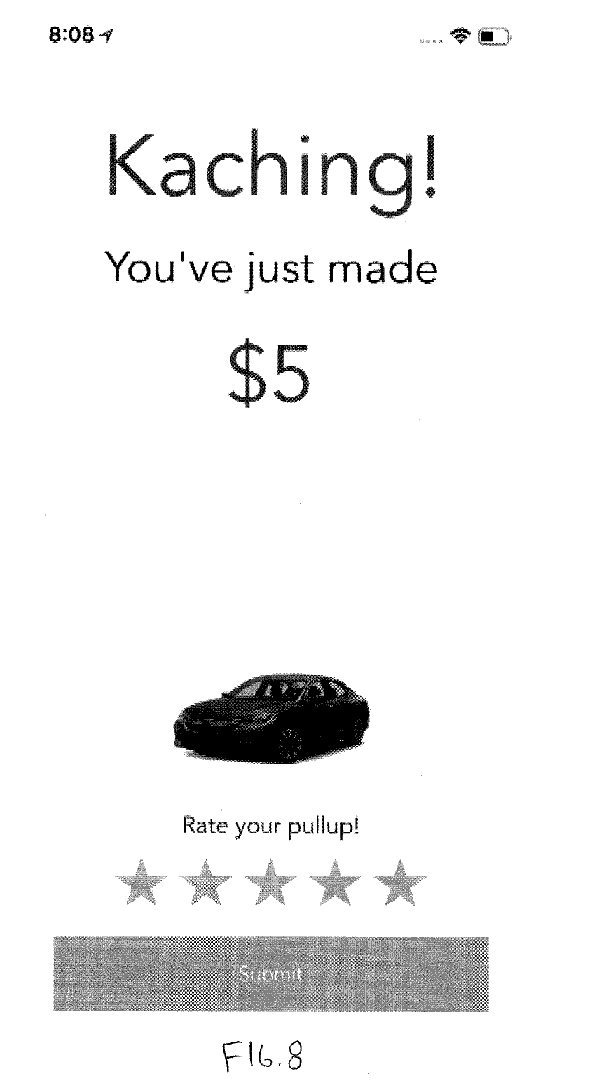

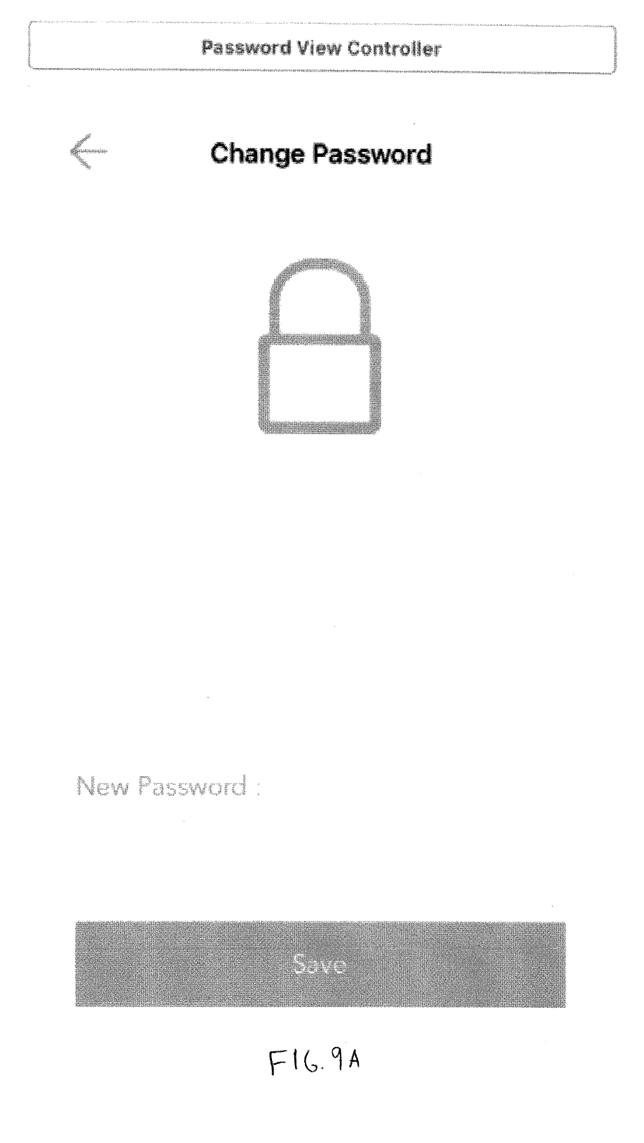

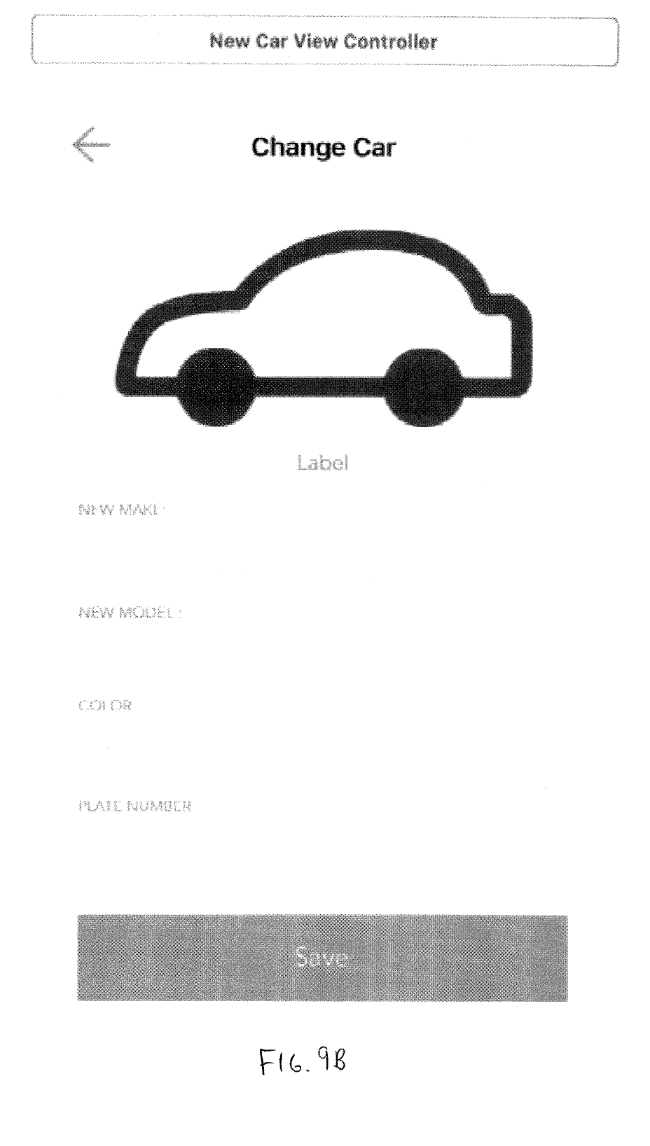

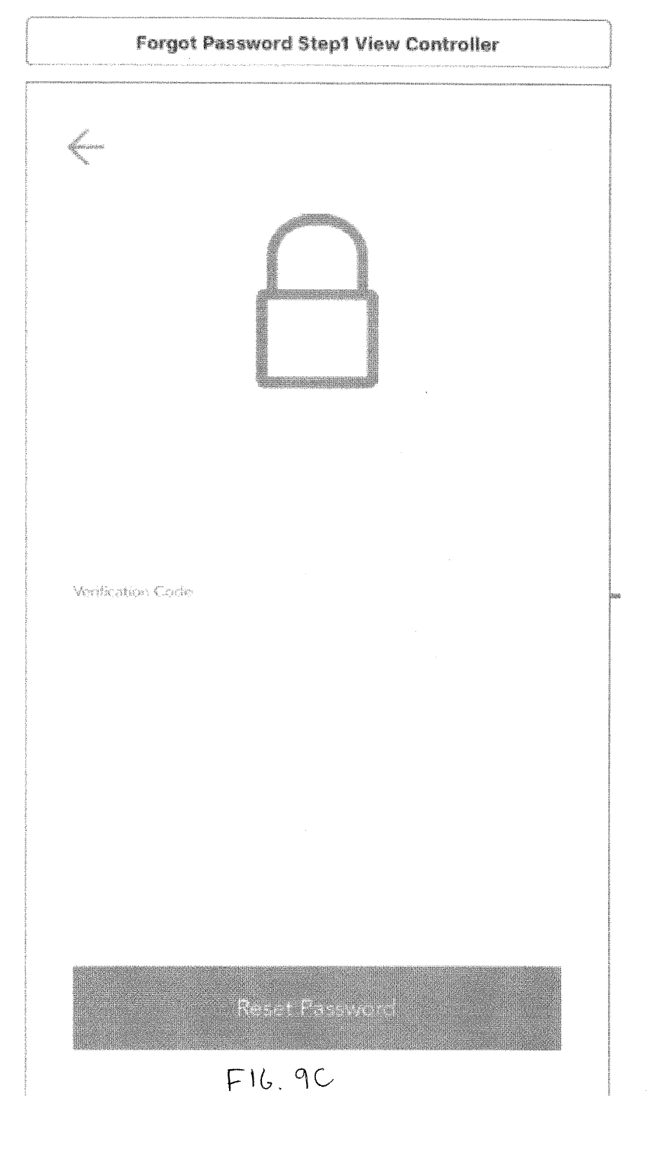

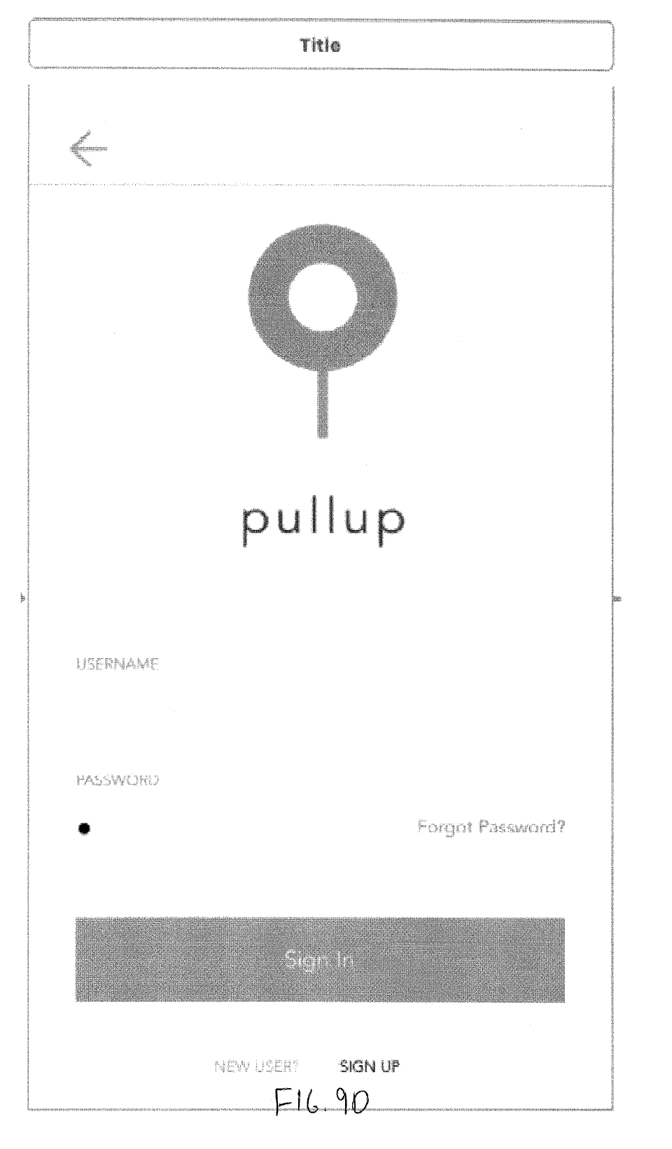

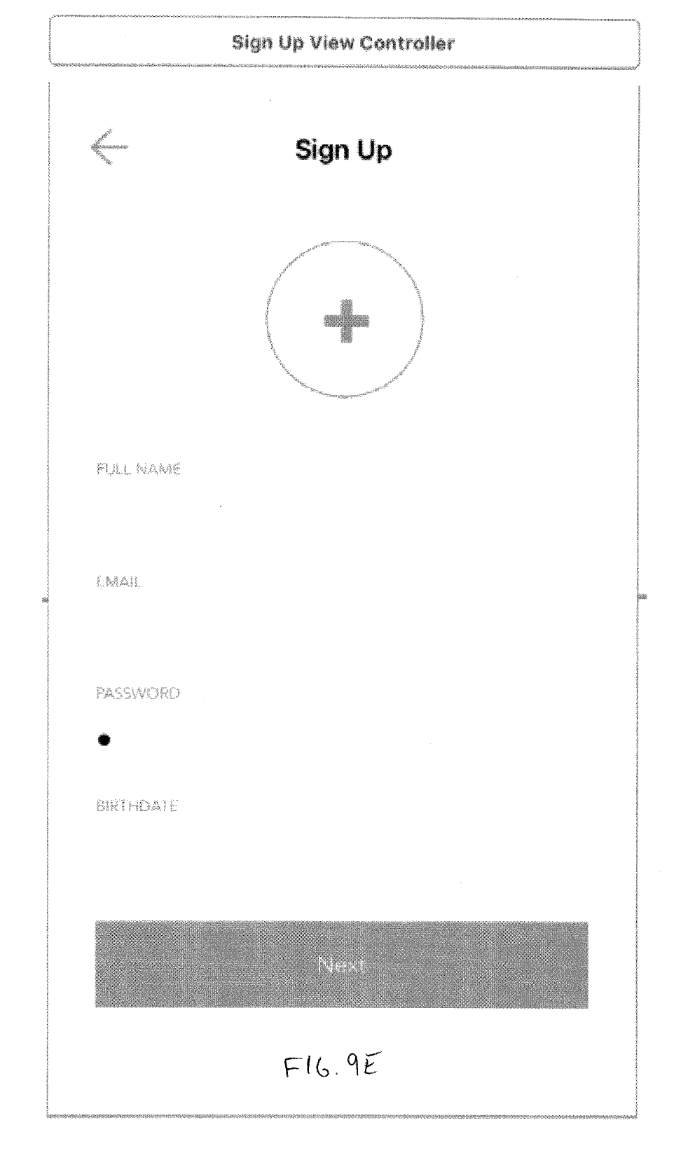

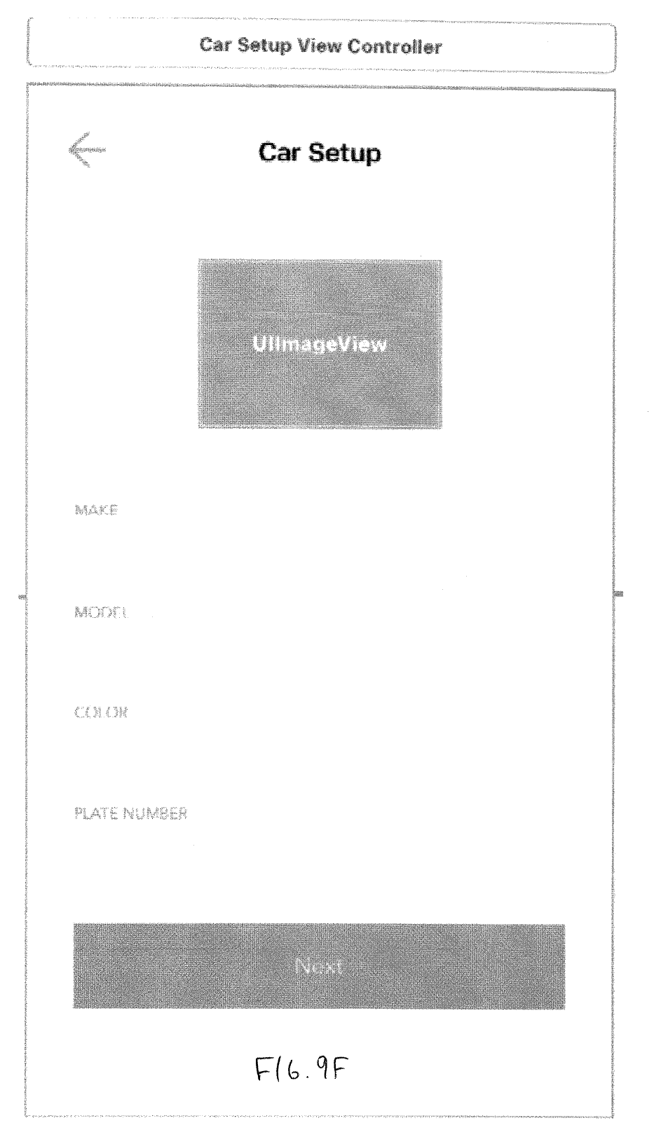

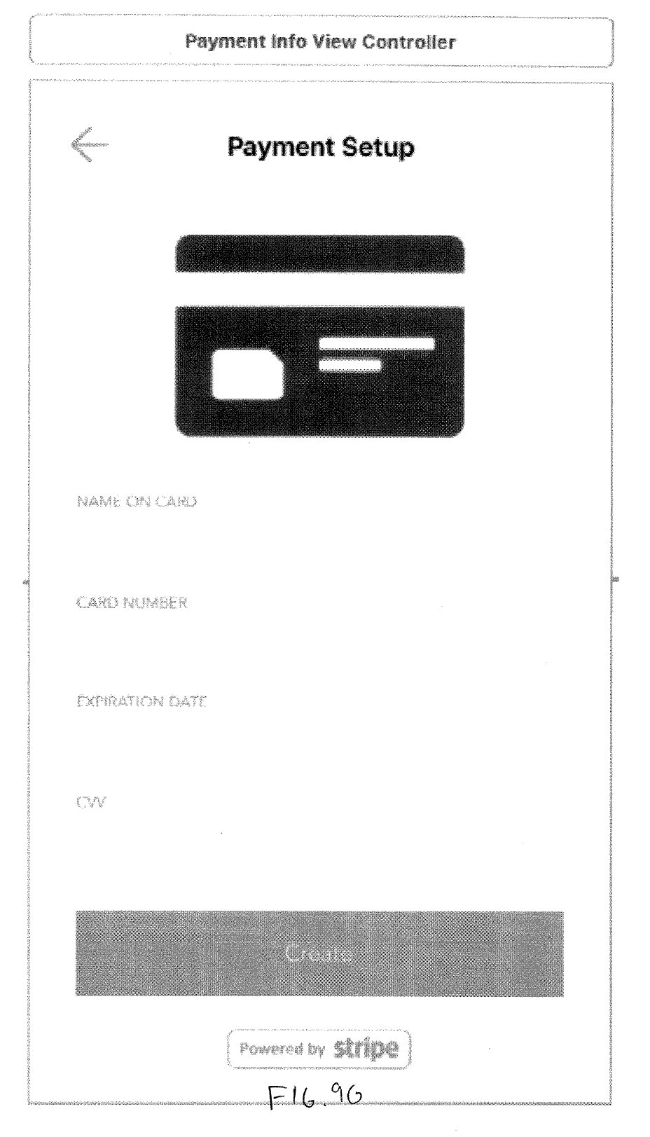

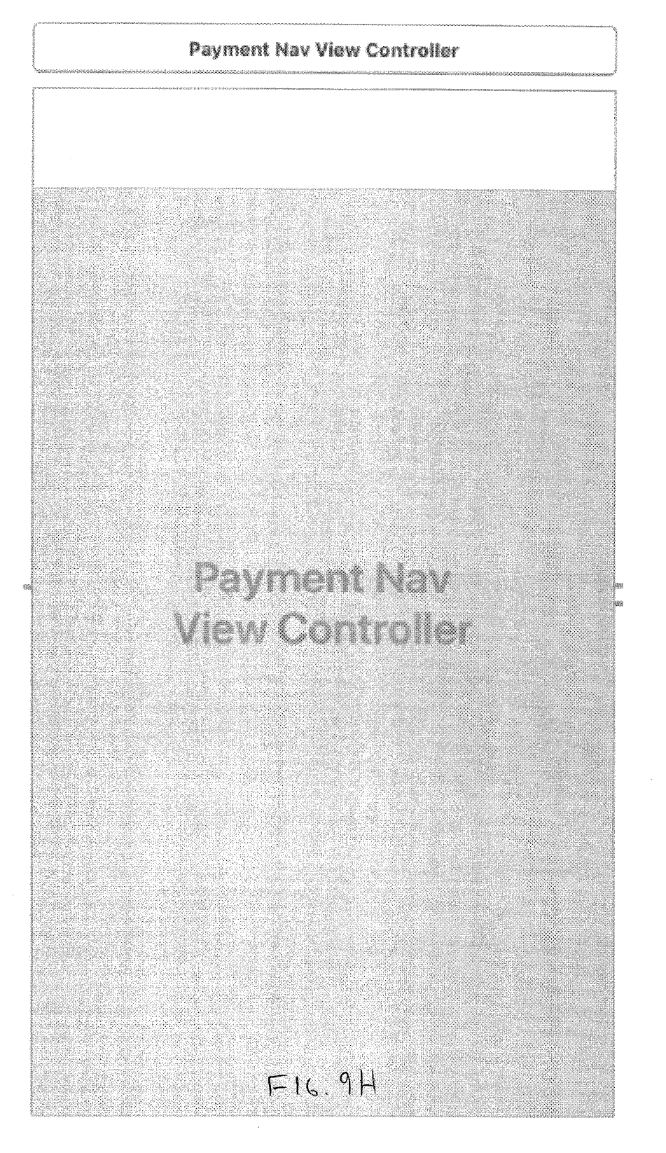

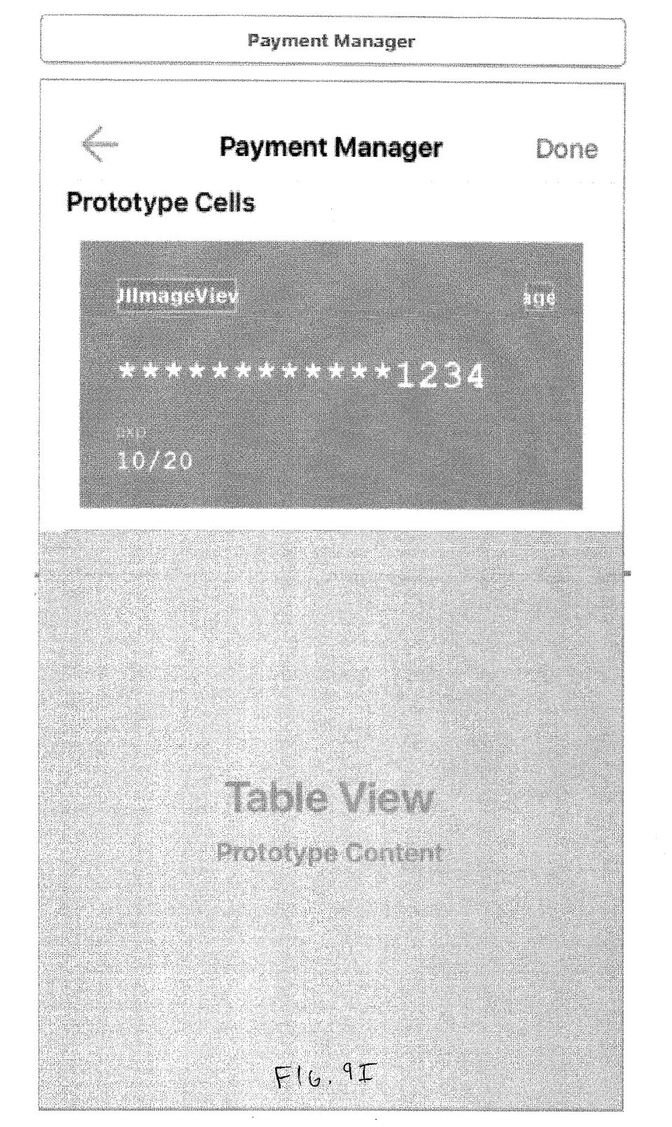

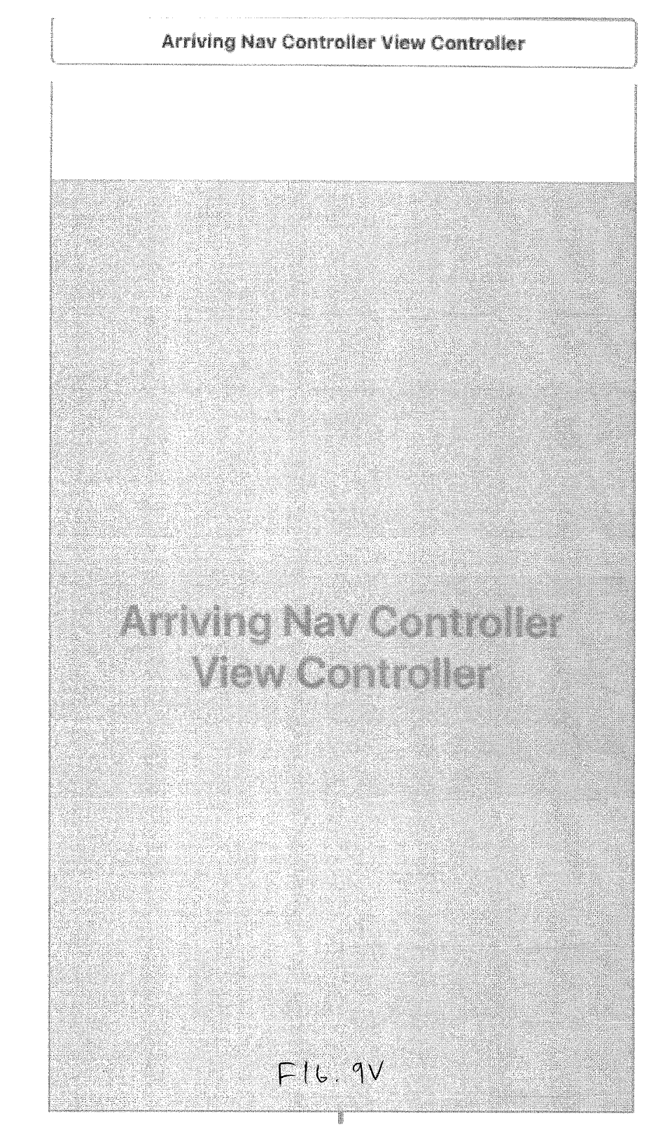

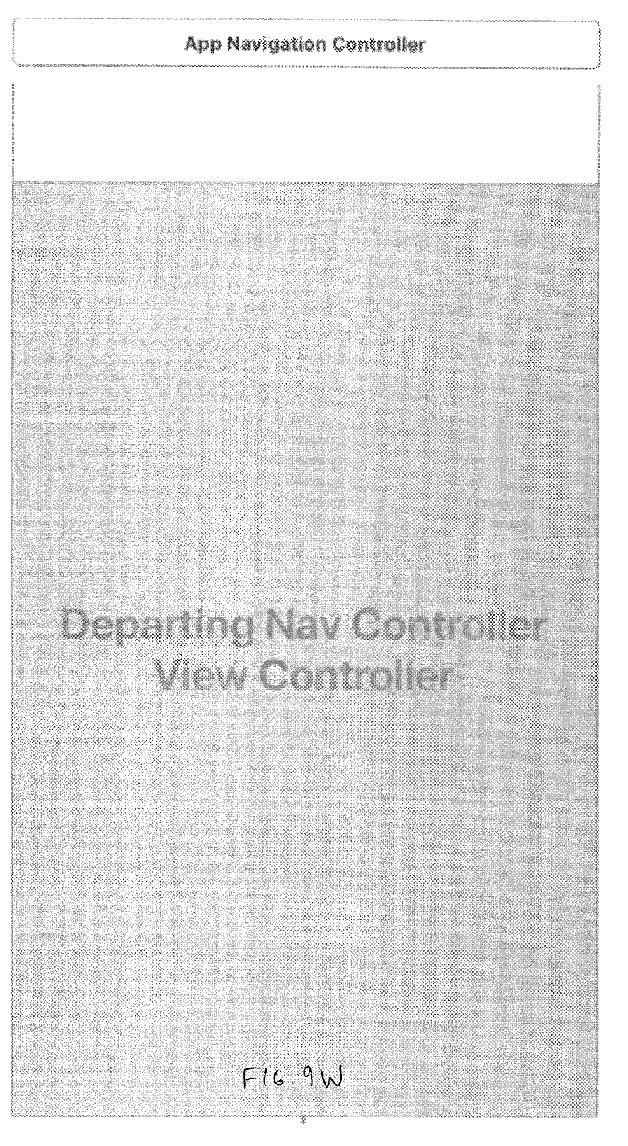

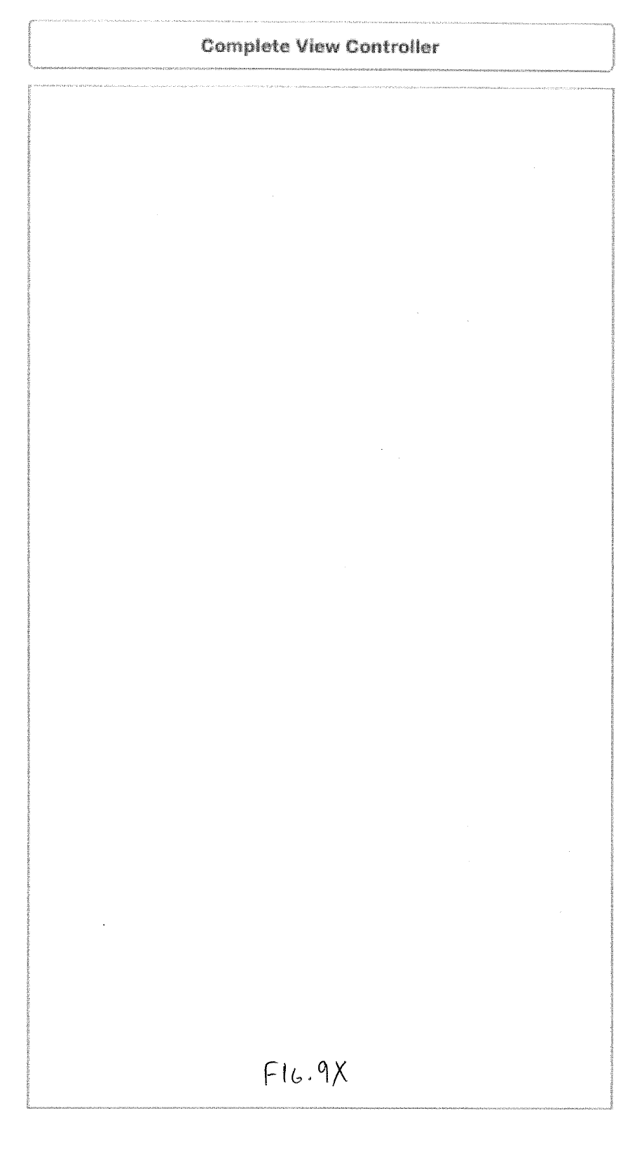

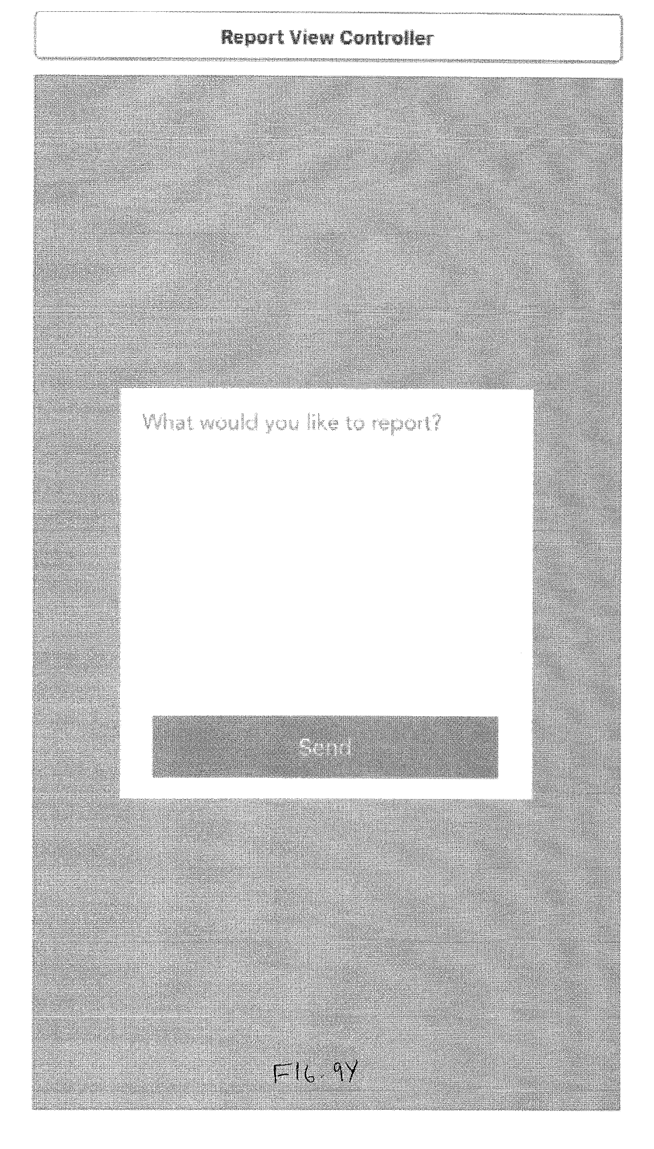

In FIG. 4, this is one of the final stages of the successful transaction process, this screen is similar to what will be shown to the arriving user when both users have completed the rendezvous described in FIG. 3. Similarly, the departing user will be shown a screen similar to FIG. 8 upon a successful rendezvous with the opposite arriving party.

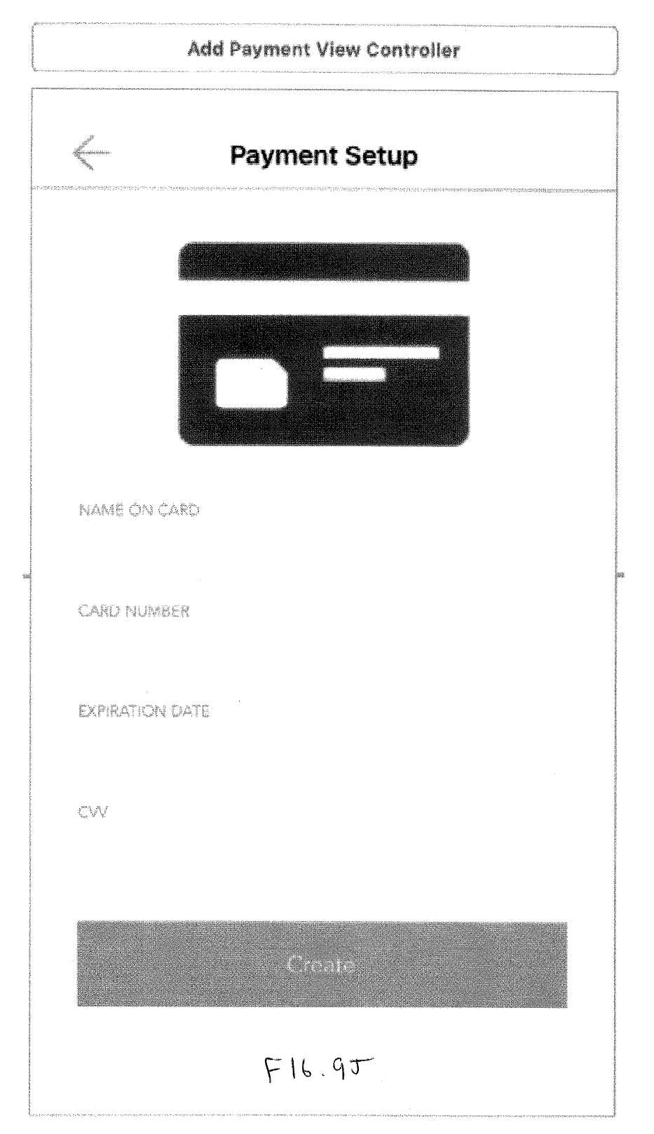

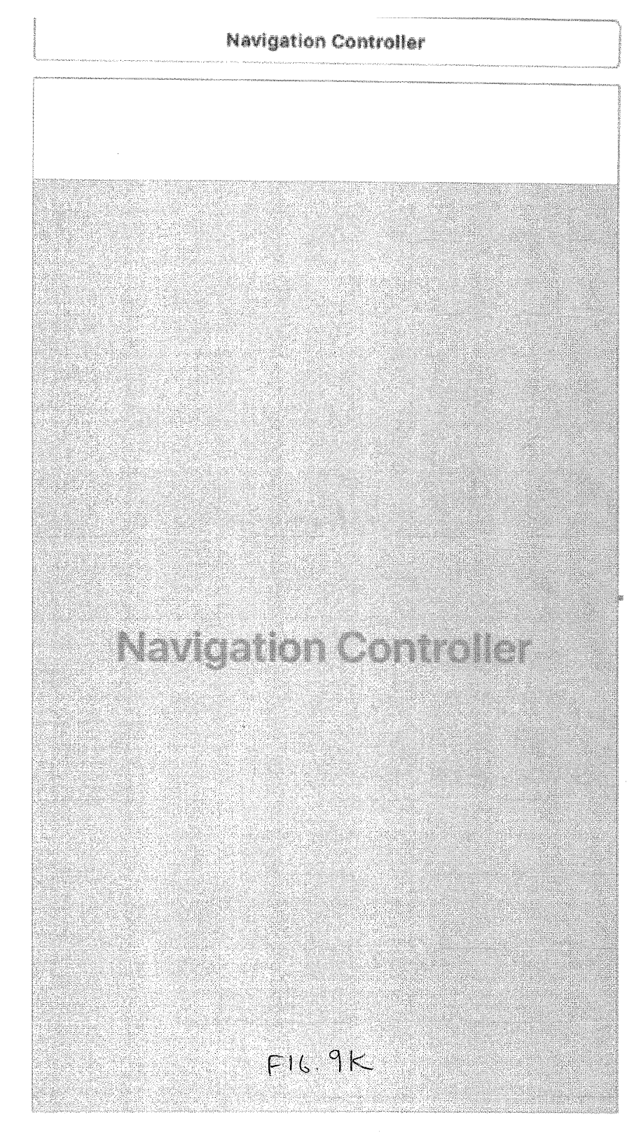

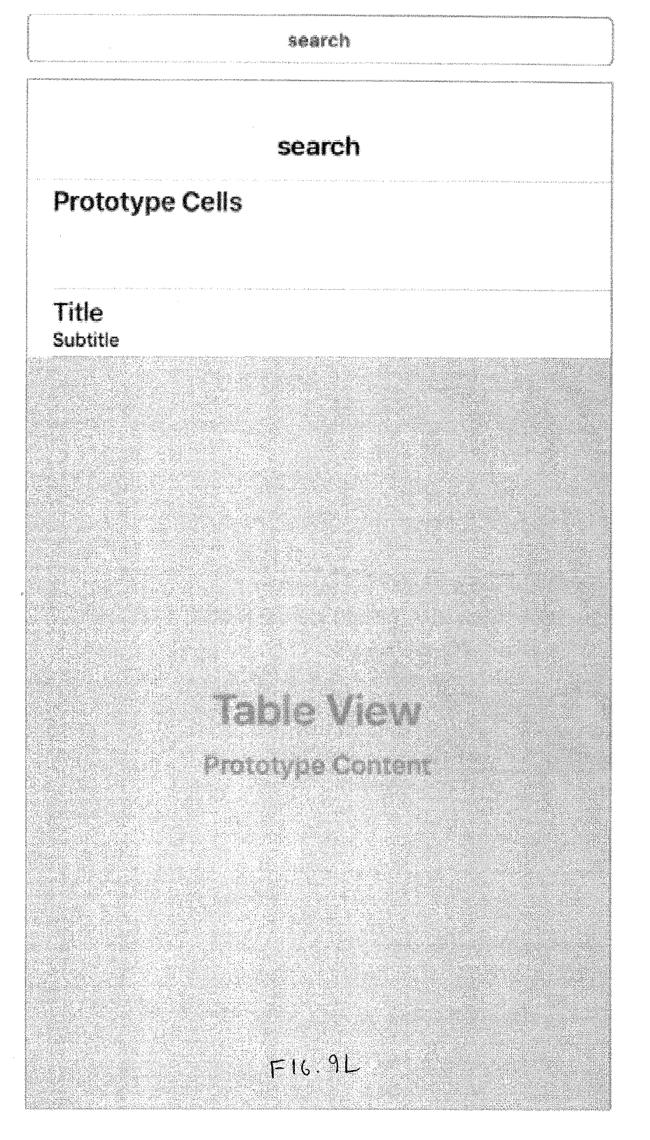

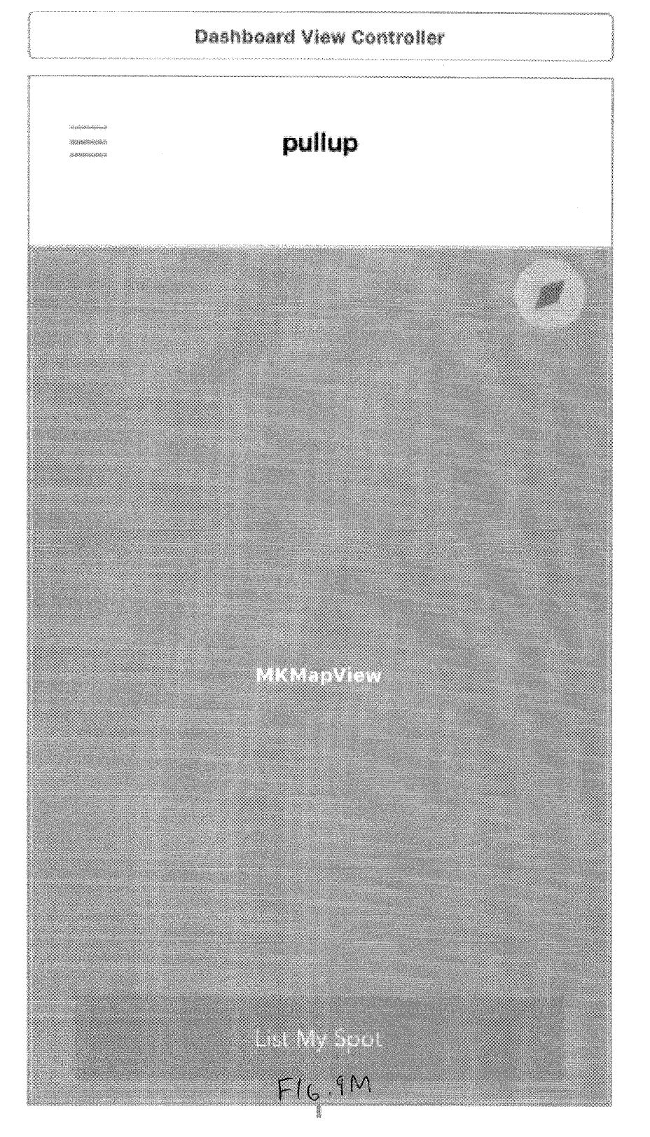

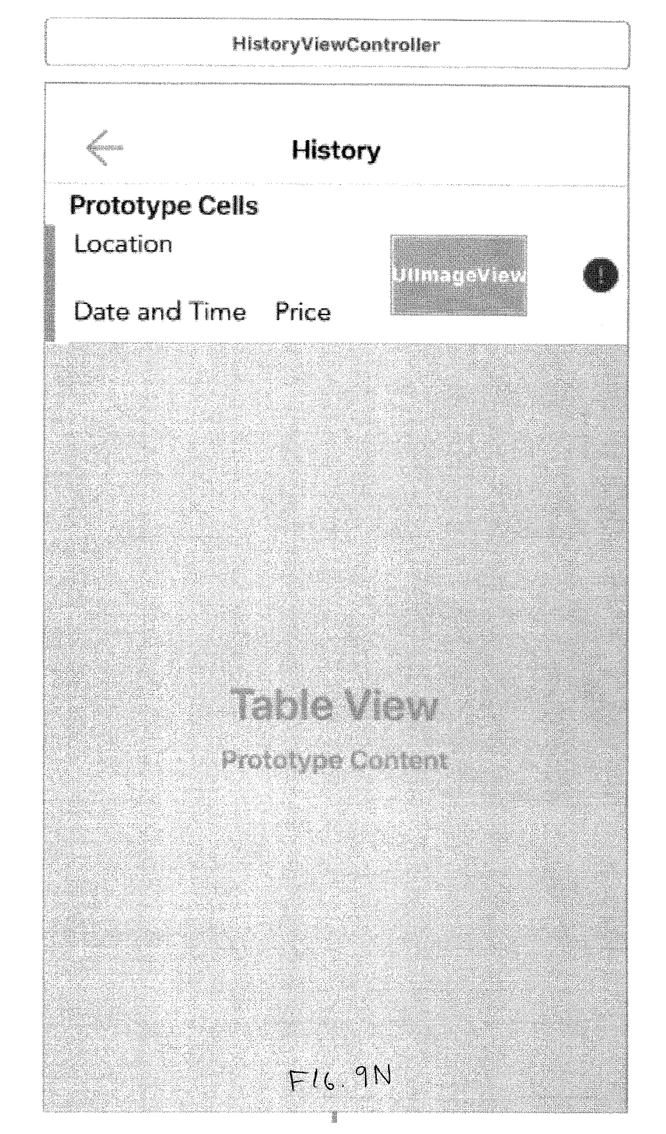

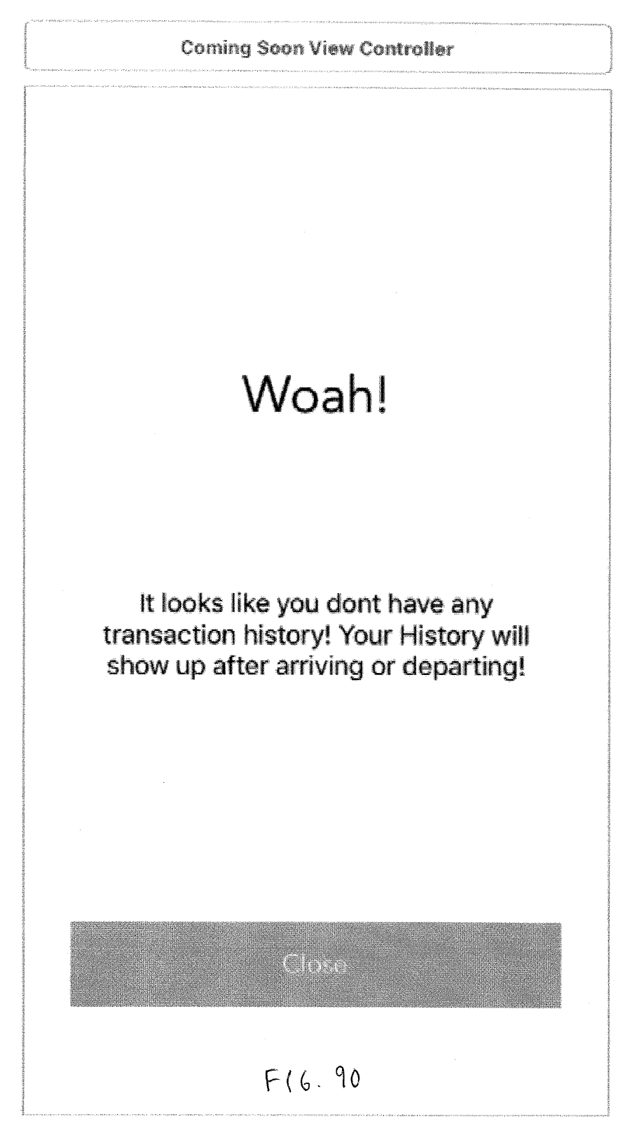

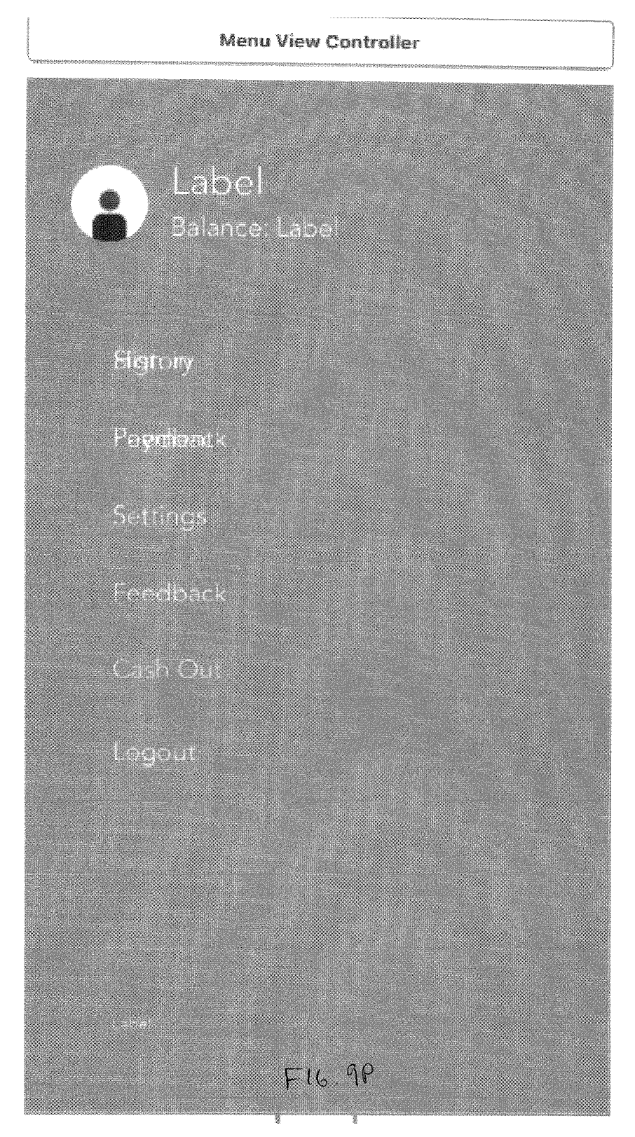

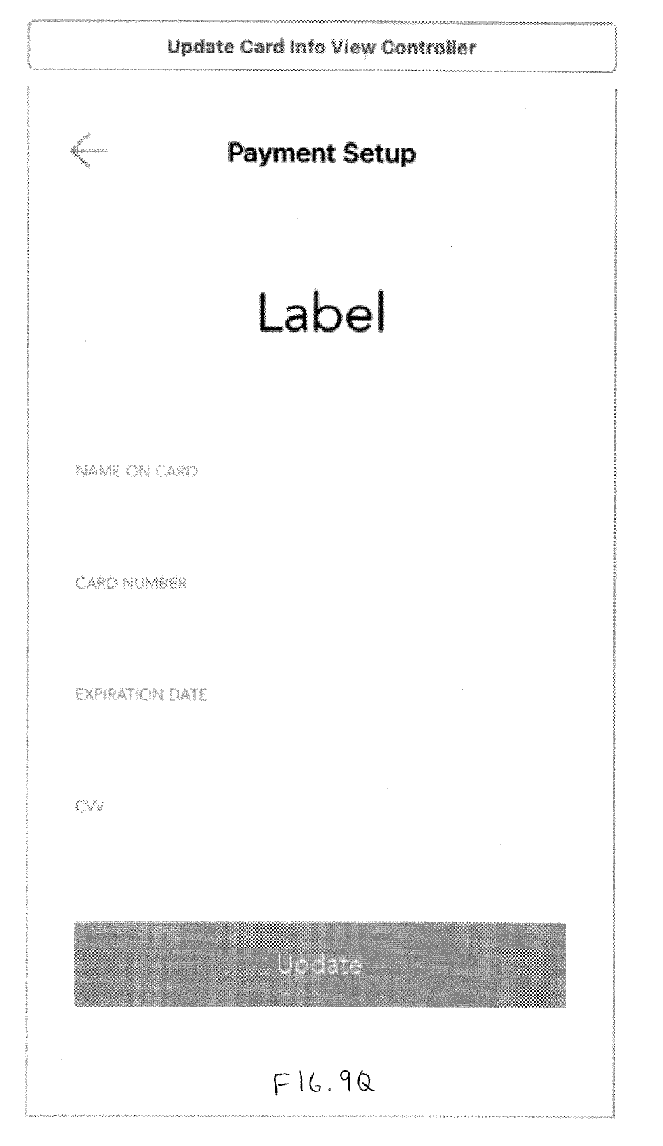

In FIG. 5, this screen is shown when a user successfully inputs the desired wait time and price for the space shown in FIG. 1. Once a user initiates option “Next” in FIG. 1, that departing user is prompted to FIG. 5 in which he is searching for an arriving user to reserve the parking space listed. This search screen is shown for as long as the wait time set by the departing user. Shown in FIG. 6, in this step of the process an arriving user is selecting the parking space of their choice. The user is prompted with information about the parking space they selected to ensure the validity of the selection and a pop-up confirmation message or similar is presented to ensure this is the transaction they want to initiate.

FIG. 7 this is the initial screen in which the app startup will center. The map will be centered on the pullup pin in the center of the screen where the current user's location is. A user can search a location in the search criteria (e.g. 207-299 W 50th St New York, N.Y., or a location e.g. New Jersey Institute of Technology) in order to obtain parking spaces that have been listed and are available within the area of the specified search location. The user can alternatively also has an option to start departing from their current parking space. In which the user will be prompted with a screen similar or identical to the one described in FIG. 1.

In FIG. 8, this is one of the final stages of the successful transaction process, this screen is similar to what will be shown to the departing user when both users have completed the rendezvous described in FIG. 3. Similarly, the arriving user will be shown a screen similar to FIG. 4 upon a successful rendezvous with the opposite party.

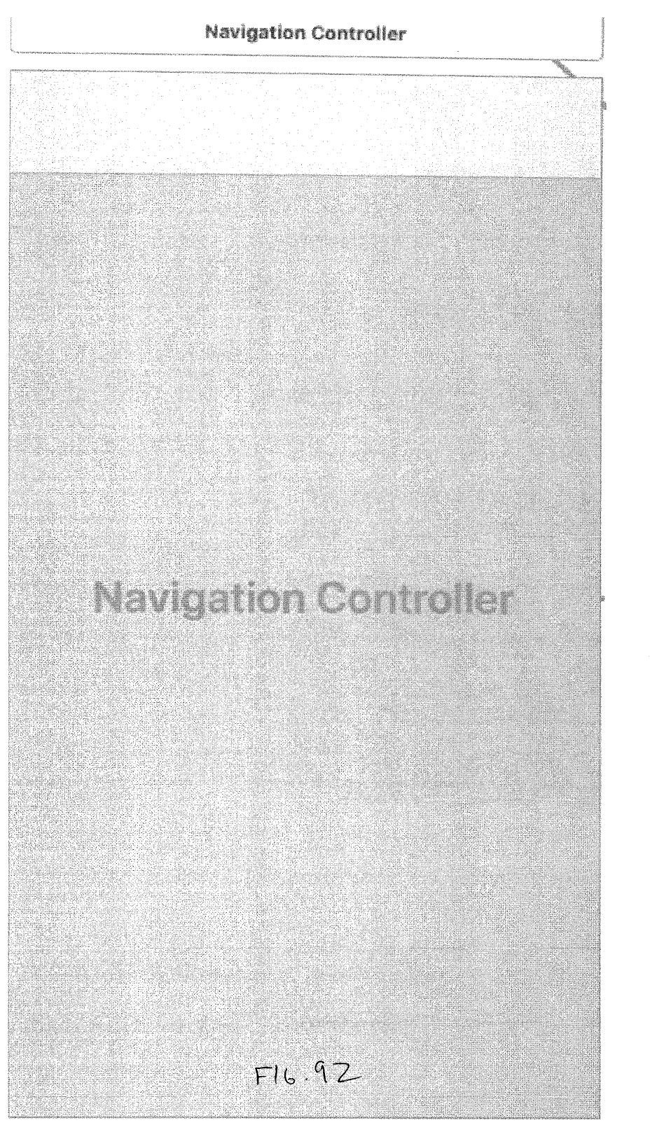

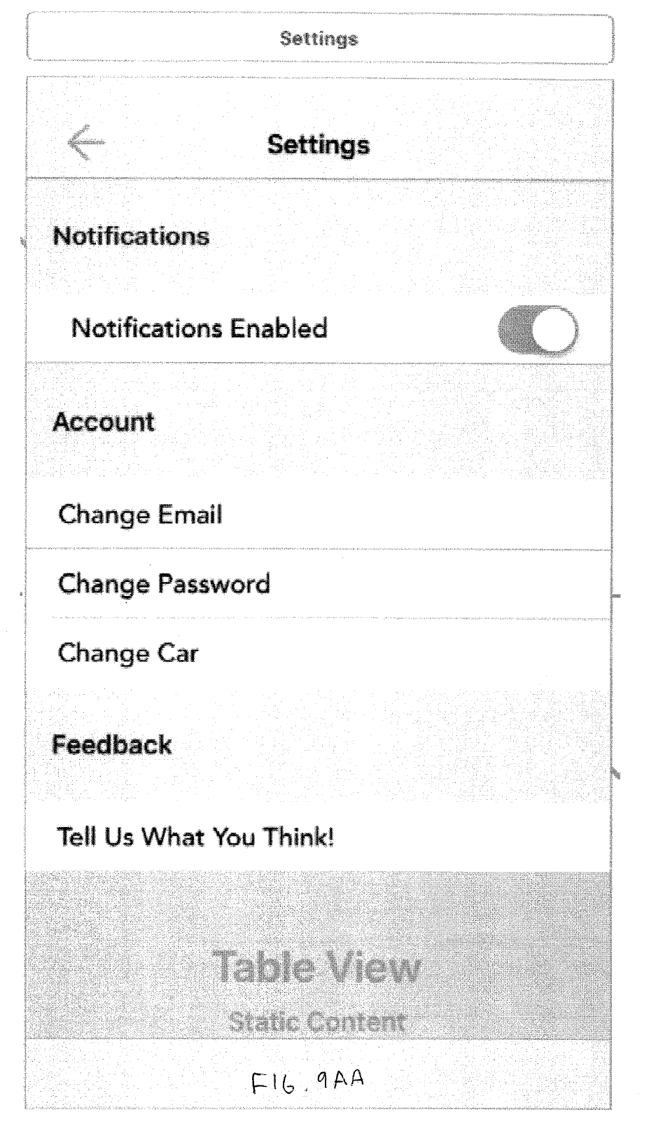

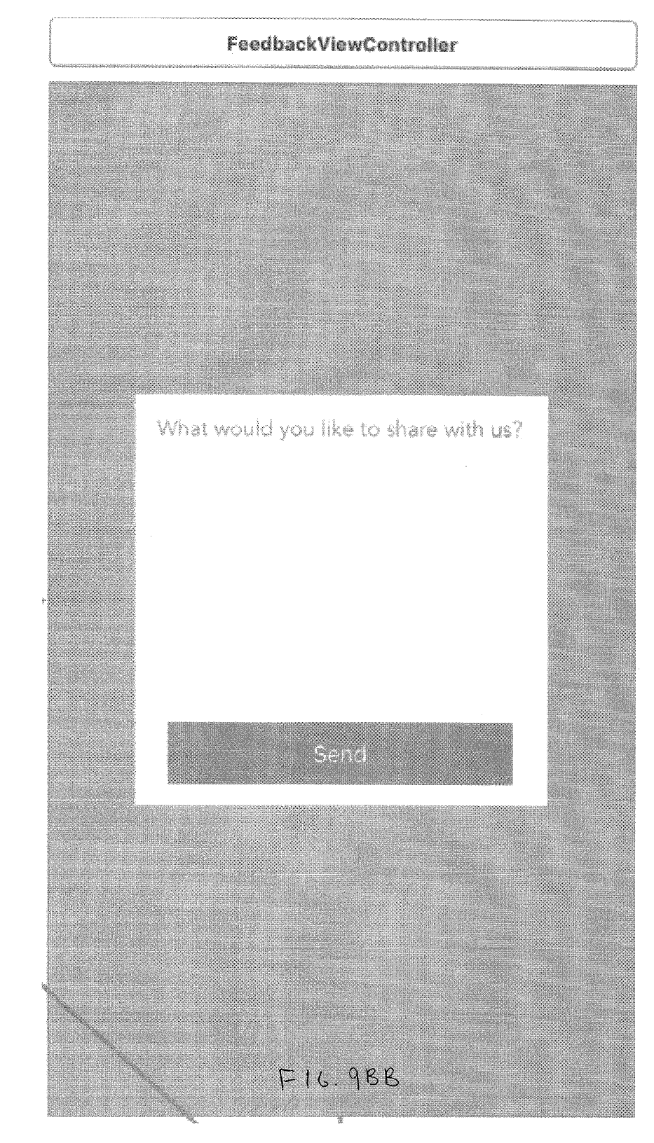

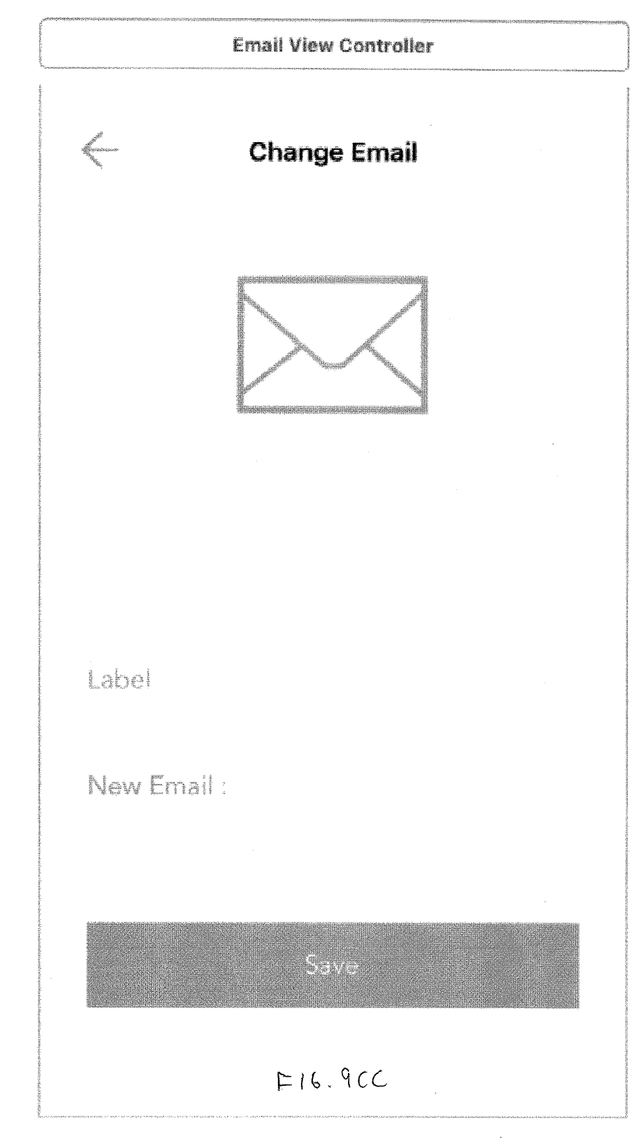

FIGS. 9A-9CC displays the process by which the user interfaces with the application. The FIGS. show the login process and similar functions, such as forgot password and the sign-up process, in which the user enters personal, vehicle, and payment information to be used within the application. Further, shown are the initial pages of the application in which the user can interact with the map through the processes of the application or enter various settings pages. In addition, shown are the different settings pages available to the user and more specific pages around the processes of the application and their completion pages.

In general, the embodiments of the present invention require at least a central database or repository to store and facilitate the transmittal of information between parties utilizing the application. The database may comprise one or more individual databases or may comprise only a singular database. In one embodiment, there is a parking system program parking database configured to store criteria associated with one or more parking locations. Such criteria may be at least one of a waiting period, a compensation level, a location, and a type of a parking location, or a combination thereof. In some embodiments, there is a parking system program user database configured to store criteria associate with one or more users. Here, the criteria may be at least one of a location preference, a rating, a description of at least one vehicle, and usage history, or a combination thereof. In other embodiments, the information contained in each of the aforementioned databases is stored in databases.

Users of the present invention and its embodiments, may first start by creating an account with the application. The user may be able to designate themselves as an arriving user, a departing user, or may be able to fluidly transition between taking on the role of an arriving user and a departing user. As used herein “arriving user” is considered to be a user that is in an arriving state searching for listed spots available at their destination. An arriving user has the ability to see all parking spots that have been listed within the area they're looking at in the map. As used herein “departing user” is considered to be one that is in a departing state and has listed a parking spot. A departing user has the ability to list a parking spot by using the app's pin to show its location and specifying the time they're willing to wait and the amount of money they want to be compensated for that time. Furthermore, a departing user has the ability to cancel and reconfigure the listing process.

As shown in FIG. 1, a departing user is in the process of listing a particular parking location. The parking location may be one or more public, commercial, residential, or private parking locations occupied by the departing user. For example, the parking location may be a particular position along a road for which the departing user is parked in.

Here, the departing user must list at least two variables attributable to the parking location. The first variable is the price for the parking location. The price may be whatever price the departing user is comfortable listing the parking location. Further, the price may be influenced by the second variable, time. The time variable is the approximate time the departing user would like to wait for the arriving user to pullup and exchange the parking space. The time may be an integer, or other number format, corresponding to a number of minutes, or other time denomination, for which the departing. In other instances, markedly longer time frames or ranges may be given (e.g. one week). The time variable can be custom tailored to the departing user's needs. As shown in FIG. 5, once the departing user lists the spot he is put into a waiting mode, in which he waits for an arriving user to select his spot and a match followed by a rendezvous to occur.

Once the departing user has set a price and a time for the parking space, the price may be modified by the application. In at least one embodiment, the price designated by the departing user of the parking location is multiplied by 1.2 (1.2×) and then rounded up to the nearest whole number. This new or modified price is the listing price that an arriving user would see upon accessing the application and viewing that particular parking location. For example, if the departing user set the price of the parking location to $6, the application would set the new or modified price to $8 ($6×1.2=$7.2, rounded up to $8). This listing price of $8 is shown to potential arriving users in the listed annotation (see FIG. 7) in the application. In practice, this is done as part of a pricing structure enabling the application to provide a steady stream of income to both the departing user and the owner of the application.

An annotation, as described herein, is simply the visual representation of a parking location that has been listed by a departing user (see FIG. 3 and FIG. 7). The number of annotations shown to a user at any given time may be controlled by the user themselves. In other embodiments, the number of annotations presented to a user are calculated algorithmically and may be constrained by the pixel density of screen based on the logic desired. Specifically, this logic may refer to screen zoom, average prices, surge prices, desired number of spots/screen, location, and other conceivable factors and various combination thereof. In one embodiment, the application will utilize the arriving user's location and the location of all existing parking locations listed by departing users in the application's server to calculate an estimated arrival time between the arriving user and all of the stored parking locations in order to determine whether to show or not show the annotation to the arriving user. This is done to only show listed annotations to the arriving user in which the estimated arrival time between the arriving user and the listed location is less than the time the departing user of the parking location has chosen to wait.

Once an arriving user has selected and acknowledged (see FIG. 6) the departing user's parking location, the application can enter into a rendezvous mode as shown in FIG. 3. A rendezvous takes place when there is a pairing/match of an arriving user with a departing user. The two then go into rendezvous mode where both parties can see each other's vehicle information and location. Generally, the rendezvous mode will provide each of the arriving user and the departing user with some combination of the following: an estimated a time of arrival of the arriving user to the parking location, providing vehicle information of the arriving user to the departing user, and providing vehicle information of the departing user to the arriving user. In this rendezvous mode, the arriving user drives to the departing user's location and the exchange of the parking spot occurs.

In order to help facilitate this exchange process, the arriving user's location and the location of the parking location in the application's server calculates the estimated time between the two locations and displays that time to the both users in rendezvous mode. The arriving user and departing user can then see the movement of one user relative to the other in real time. This tracking allows for a transactional verification to be performed based on the location of the two or more users at the rendezvous and not beforehand. A method of acknowledgement of both parties may also be used to ensure the transactions occurs successfully. Thus, the transaction occurs and is finalized at the point in which an arriving user meets with a departing user and can be determined via acknowledgement in the application or through each user's location as determined by GPS or other suitable location tracking system.

The exchange of the parking location can now occur between the users. Further, as shown in FIG. 4 and FIG. 8, in the event of a successful transaction the screen appears to the users as the figures show with pricing and vehicle information and there is a rating system for rating the process and, in particular, rating a user. The rating system allows both arriving user and departing users to rate each other. The respective users' rating is displayed as one of the information elements of a listed parking location, during rendezvous mode, and elsewhere in the application.

Additionally, as it is recognized that a transaction may not always go smoothly, there is a fine system in place to potentially penalize arriving users or departing users for their conduct in the transaction. For example, a fine may be implemented if a cancellation occurs after a fixed or variable time period after entering rendezvous mode. The fine, in some embodiments, will consist of a fixed or variable monetary amount or percentage of the total transactional price awarded to the non-cancelling party (either arriving user or departing user). Other implementations of such a system may further be utilized.

Once a user has obtained some amount of money in the account due to the occurrence or one or more transactions, a user may “cash out.” A user can cash out the amount of money that is held in the application account balance that is earned from listing parking locations. The user selects the cash out feature in the application, enters information required by the application processor for the monetary transaction, and selects the dollar amount that they want to receive.

After completion, the user is credited the dollar amount that they selected to their inputted choice of payment to an account of their choosing, in the present embodiment, demonstrated as an ACH transfer.

In some embodiments, the application server may maintain logs of transactions containing information such as location, time and vehicle information, and pricings to populate databases that can allow for future data mining, tracking of parking events, vehicle/space location movement, and other iterations of data clusters. A user's transaction history may also be displayed to users in the application. Further, data from parking events/space exchange events over hourly, daily, weekly, monthly or seasonal/yearly trends can be extrapolated from the transaction data. This data and other collected data can be used to determine census, parking/space availability, mobility trends, and other similar trends within a city, state, region, or world.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed is:

1. A system for managing at least one parking space, the system comprising:
a parking system program executed by at least one electronic device, the parking system program having a rendezvous module,
wherein the rendezvous module is activated when a user accepts at least one parking location, the rendezvous module performing the steps of:
estimating a time of arrival of the second user to the first parking location;
providing first vehicle information of the first user to the second user; and
providing second vehicle information of the second user to the first user;
providing, to the second user, a first user location with directions to the first user; and
providing, to the first user, an estimated path of the second user;
a parking system program parking database configured to store criteria associated with one or more parking locations,
wherein the criteria is at least one of a waiting period, a compensation level, a location, and a type of a parking location;
a parking system program user database configured to store criteria associated with one or more users,
wherein the criteria is at least one of a location preference, a rating, a description of at least one vehicle, personal user information, payment processing information, and usage history.

2. The system of claim 1 wherein the first vehicle information comprises a license plate number, a color, a model, a manufacturer, a length, a width, a GPS location, a present location capture and storage, a past location capture and storage, IP address, or a combination thereof.

3. The system of claim 1 wherein the second vehicle information comprises a license plate number, a color, a model, a manufacturer, a length, a width, a GPS location, a present location capture and storage, a past location capture and storage, IP address, or a combination thereof.

4. The system of claim 1 wherein the waiting period comprises a time period for which the departing user is willing to wait.

5. A computer implemented parking method comprising:
a first user inputting criteria for a first parking location into a parking system program,
wherein the criteria comprises at least a waiting period and a compensation level,
wherein the compensation level is modified by the parking system program to provide a modified compensation;
a second user selecting the first parking location from one or more parking locations in the parking system program,
wherein if the second user places a reservation of the first parking location, then the parking system program enters a rendezvous mode, wherein the rendezvous mode comprises the steps of:
the parking system program estimating a time of arrival of the second user to the first parking location;
the parking system program providing first vehicle information of the first user to the second user;
the parking system program providing second vehicle information of the second user to the first user;
providing, to the second user, a first user location with directions to the first user; and
providing, to the first user, an estimated path of the second user.

6. The method of claim 5 further comprising the steps of:
compensating the first user by the second user for waiting to leave a space.

7. The method of claim 6 wherein the compensation occurs based on a position of an electronic device of the first user to a position of an electronic device of a second user, or acknowledgement of both parties or upon cancellation.

8. The method of claim 5 wherein the modified compensation is calculated by multiplying the compensation level by a variable and rounding up or down to the closest whole number.

9. The method of claim 5 wherein the one or more parking locations are parking spaces allowing vehicle occupancy.

10. The method of claim 5 further comprising the step of:
penalizing, either the first user or the second user, with a fine if the reservation is canceled after a first period after initialization of the rendezvous mode.

11. The method of claim 10 wherein the fine is a fixed or variable amount of a percentage of a price of the first parking location.

12. A non-transitory computer-readable medium storing computing instructions for operation of a parking system program, the computing instructions operating upon a portable computerized device and configured to instruct the portable computerized device to perform acts, comprising the steps of:
a first user inputting criteria for a first parking location into a parking system program,
wherein the criteria comprises at least a waiting period and a compensation level, wherein the compensation level is modified by the parking system program;
a second user selecting the first parking location from one or more parking locations in the parking system program,
wherein if the second user accepts the first parking location, then the parking system program enters a rendezvous mode, wherein the rendezvous mode comprises the steps of:
the parking system program estimating a time of arrival of the second user to the first parking location;
the parking system program providing first vehicle information of the first user to the second user; and
the parking system program providing second vehicle information of the second user to the first user;
providing, to the second user, a first user location with directions to the first user; and
providing, to the first user, an estimated path of the second user.
